(19) United States
(12) Patent Application Publication
(10) Pub. No.: US 2026/0134545 A1
(43) Pub. Date: May 14, 2026

(54) GENERATING MULTIPLE SEGMENTATION MASKS IN A SINGLE MODEL WITH MULTI-TASK QUERY DECODERS

(71) Applicant: Adobe Inc., San Jose, CA (US)

(72) Inventors: Jason Wen Yong Kuen, Santa Clara, CA (US); Zijun Wei, San Jose, CA (US); Kangning Liu, San Jose, CA (US); Brian Price, San Jose, CA (US); Hyun Joon Jung, Monte Sereno, CA (US); Scott Cohen, Sunnyvale, CA (US)

(21) Appl. No.: 18/941,579

(22) Filed: Nov. 8, 2024

(51) Int. Cl. G06T 7/12; G06T 7/194; G06V 10/25; G06V 10/44; G06V 10/771

(52) U.S. Cl. CPC G06T 7/12; G06T 7/194; G06V 10/25; G06V 10/44; G06V 10/771; G06T 2207/20084

(57) ABSTRACT

Methods, systems, and non-transitory computer readable storage media are disclosed for performing a plurality of image segmentation tasks via a multi-task segmentation neural network. The disclosed system extracts, utilizing an image encoder neural network, encoded feature maps from a digital image. The disclosed system generates, utilizing a pixel decoder neural network, a set of mask features from the encoded feature maps generated by the image encoder neural network. Additionally, the disclosed system generates, utilizing a plurality of query decoder neural networks in connection with a plurality of segmentation tasks for the digital image, a plurality of object segmentation masks from the set of mask features generated by the pixel decoder neural network according to a plurality of separate sets of learned queries.

### BACKGROUND

The increased capabilities and prevalence of machine-learning, especially neural networks, in image processing has improved the number and types of tools for editing digital images. For example, many digital image editing processes involve various image segmentation tasks that identify and separate certain portions from other portions of digital images (e.g., object segmentation, foreground/background segmentation). Because machine-learning has increased the capabilities and availability of many image editing operations for users of different skill levels, accurately and efficiently performing such image editing operations is an important aspect for many software applications. Specifically, many neural networks require significant computing resources (e.g., CPU/GPU processing capabilities) to perform various tasks, frequently resulting in trade-offs between performance and flexibility. For instance, due to the size of many neural networks, implementing certain operations on devices with lower resource availability (e.g., many mobile devices) is a challenging task.

### SUMMARY

One or more embodiments provide benefits and/or solve one or more of the foregoing or other problems in the art with systems, methods, and non-transitory computer readable storage media for performing various image segmentation tasks with selective region refinement via a plurality of neural networks for image editing operations. In one or more embodiments, the disclosed systems utilize a multi-task segmentation neural network to perform a plurality of image segmentation tasks via a plurality of separate task query encoders. In particular, the disclosed systems utilize a model including a single encoder architecture with a plurality of separate query encoders to extract features from a digital image and generate object segmentation masks via a plurality of separate segmentation tasks corresponding to the separate query encoders. In one or more embodiments, the disclosed systems include a single pixel decoder to generate a set of mask features from which the plurality of query decoders generate the object segmentation masks. In alternative embodiments, the disclosed systems include a plurality of pixel decoders that generate separate sets of mask features based on the extracted features for providing to the separate query decoders.

In additional embodiments, the disclosed systems include a mask refinement neural network to refine one or more segmentation masks for a digital image. Specifically, the disclosed systems train the mask refinement neural network by generating a dataset including a plurality of simulated masks via various mask modification operations to ground-truth masks of digital images. For example, the disclosed systems generate simulated masks by synthetically filling holes, downscaling/upscaling, or otherwise modifying the ground-truth masks. Additionally, the disclosed systems utilize the mask refinement neural network to generate estimated refined masks from a training dataset including the simulated masks, and in some cases coarse masks, of the digital images. In one or more embodiments, the disclosed systems also train the mask refinement neural network by determining a matting loss between the estimated refined masks and the ground-truth masks via randomly selected point-sampling operations.

In one or more embodiments, the disclosed systems also utilize a mask refinement neural network to selectively refine region masks of coarse masks of digital images. In particular, the disclosed systems utilize a mask generation neural network to generate one or more coarse/base masks for a digital image. The disclosed systems detect separate connected portions (e.g., visually separate objects) of a base mask to determine separate regions in the base mask and generate bounding boxes for the separate regions. Based on the generated bounding boxes, the disclosed systems generate a plurality of separate refined region masks for the separate regions and combine the separate refined region masks into a final mask for the digital images. In one or more additional embodiments, the disclosed systems use one or more mask scores to select from a plurality of base masks for selectively refining and presenting masking options in a graphical user interface.

### BRIEF DESCRIPTION OF THE DRAWINGS

Various embodiments will be described and explained with additional specificity and detail through the use of the accompanying drawings.

FIG. 1 illustrates an example system environment in which a mask generation system including a multi-task segmentation system, a subject selection system, and a mask refinement system operates in accordance with one or more implementations.

FIG. 2 illustrates a diagram of an overview of the mask generation system utilizing the systems of FIG. 1 to generate a mask for a digital image in accordance with one or more implementations.

FIG. 3 illustrates a diagram of the multi-task segmentation system generating a plurality of image masks from a digital image via a plurality of segmentation tasks in accordance with one or more implementations.

FIG. 4 illustrates a diagram of the multi-task segmentation system utilizing a single pixel decoder with a plurality of query decoders to perform a plurality of segmentation tasks in accordance with one or more implementations.

FIG. 5 illustrates a diagram of an example query decoder in accordance with one or more implementations.

FIG. 6 illustrates a diagram of a plurality of task adapter neural networks for query decoders in accordance with one or more implementations.

FIG. 7 illustrates a diagram of a pixel decoder with a data-dependent upsampling layer in accordance with one or more implementations.

FIG. 8 illustrates a diagram of the multi-task segmentation system utilizing a single image encoder with a plurality of pixel decoders and a plurality of query decoders to perform a plurality of segmentation tasks in accordance with one or more implementations.

FIG. 9 illustrates a diagram of a plurality of task adapter neural networks for pixel decoders and query decoders in accordance with one or more implementations.

FIG. 10 illustrates a graphical user interface including a plurality of object masks for objects in a digital image in accordance with one or more implementations.

FIG. 11 illustrates a comparison of masks for a digital image in accordance with one or more implementations.

FIG. 12 illustrates a comparison of masks for a digital image in accordance with one or more implementations.

FIG. 13 illustrates a diagram of the mask refinement system generating a refined mask for a portion of a base mask in accordance with one or more implementations.

FIG. 14 illustrates a diagram of a mask refinement neural network for refining coarse masks in accordance with one or more implementations.

FIG. 15 illustrates a diagram of the mask refinement system training a mask refinement neural network using simulated masks with a matting loss based on point-sampling operations in accordance with one or more implementations.

FIG. 16 illustrates a diagram of the mask refinement system generating a training dataset including simulated masks and coarse masks in accordance with one or more implementations.

FIG. 17 illustrates a diagram of the mask refinement system generating simulated masks using a plurality of mask modification operations in accordance with one or more implementations.

FIG. 18 illustrates a diagram of the mask refinement system utilizing point-sampling operations to determine a matting loss for an estimated refined mask in accordance with one or more implementations.

FIGS. 19A-19B illustrate an example ground-truth mask and an example simulated mask of an object in a digital image in accordance with one or more implementations.

FIGS. 20A-20C illustrate an example digital image and example segmented objects in accordance with one or more implementations.

FIG. 21 illustrates a diagram of a subject selection system separately refining region masks of base masks of a digital image in accordance with one or more implementations.

FIG. 22 illustrates a diagram of the subject selection system determining bounding boxes and generating region masks for connected regions in a base mask in accordance with one or more implementations.

FIG. 23 illustrates a diagram of the subject selection system merging bounding boxes from a sorted list of bounding boxes for connected regions in a digital image in accordance with one or more implementations.

FIG. 24 illustrates a diagram of the subject selection system merging bounding boxes for connected regions in a digital image using a clustering algorithm in accordance with one or more implementations.

FIG. 25 illustrates a diagram of the subject selection system selecting a base mask from a plurality of base masks based on various mask scores for the plurality of base masks in accordance with one or more implementations.

FIG. 26 illustrates a diagram of the subject selection system generating a mask quality score for a base mask in accordance with one or more implementations.

FIG. 27 illustrates a diagram of the subject selection system combining refined region masks to generate a final mask in accordance with one or more implementations.

FIG. 28 illustrates a comparison of refined masks for a digital image in accordance with one or more implementations.

FIG. 29 illustrates a diagram of an example of the mask generation system in accordance with one or more implementations.

FIG. 30 illustrates a flowchart of a series of acts for using a single model with a plurality of query decoder neural networks to perform a plurality of separate segmentation tasks on a digital image in accordance with one or more implementations.

FIG. 31 illustrates a flowchart of a series of acts for training a refinement neural network using simulated masks with a matting loss determined via point-sampling operations in accordance with one or more implementations.

FIG. 32 illustrates a flowchart of a series of acts for selectively refining portions of a base mask using bounding boxes for connected regions of the base mask in accordance with one or more implementations.

FIG. 33 illustrates a block diagram of an exemplary computing device in accordance with one or more implementations.

### DETAILED DESCRIPTION

One or more embodiments of the present disclosure include a mask generation system that generates masks for objects in digital images through various segmentation tasks and refinement operations. Specifically, the mask generation system includes a multi-task segmentation system that generates a plurality of different segmentations of a digital image by leveraging a single model to perform a plurality of separate segmentation tasks. Additionally, the mask generation system utilizes a mask refinement system to train and utilize a mask refinement system to refine a coarse/base mask via a training dataset including simulated masks with a matting loss based on point-sampling operations. Furthermore, the mask generation system includes a subject selection system to selectively refine portions of a digital image via region masks corresponding to connected regions (e.g., visual separate objects) in a base mask. Thus, the mask generation system includes a pipeline of a plurality of different systems to perform image segmentation tasks and mask refinement to generate one or more masks (e.g., alpha mattes) for various objects of digital images.

As mentioned, in one or more embodiments, the mask generation system includes a multi-task segmentation system to perform a plurality of image segmentation tasks via a single model. In particular, in one or more embodiments, the multi-task segmentation system utilizes an image encoder and a pixel decoder to generate mask features for a digital image. The multi-task segmentation system utilizes a plurality of separate query decoders to perform a plurality of separate segmentation tasks from the mask features generated via the pixel decoder. In alternative embodiments, the multi-task segmentation system utilizes an image encoder with a plurality of pixel decoders to generate a plurality of separate sets of mask features from a single set of extracted features for the digital image. The multi-task segmentation system uses the separate query decoders to perform the separate image segmentation tasks (e.g., to generate separate object segmentation masks) from the sets of mask features. Furthermore, in some embodiments, the multi-task segmentation system utilizes task adapter neural networks to convert the mask features generated by the pixel decoder (or extracted features via the image encoder) to adapt features from the previous stage for the separate image segmentation tasks.

In one or more embodiments, the mask generation system also includes a mask refinement system to train and utilize a mask refinement neural network to refine coarse masks of digital images. Specifically, the mask refinement system generates a training dataset including simulated masks (and in some cases coarse masks) of digital images. For example, the mask refinement system generates the simulated masks by utilizing various mask modification operations (e.g., synthetically filling holes, downscaling/upscaling) on ground-truth masks. Additionally, the mask refinement system utilizes the mask refinement neural network to generate estimated refined masks based on the training dataset and determines a matting loss involving a plurality of different point-sampling operations for the estimated refined masks. Accordingly, the mask refinement system trains the mask refinement neural network by modifying parameters of the mask refinement neural network according to the matting loss.

In one or more additional embodiments, the mask generation system includes a subject selection system to selectively refine portions of base masks of digital images. In particular, the subject selection system identifies connected regions of a base mask representing visually distinct objects in a digital image and determines bounding boxes for the separate connected regions. Additionally, in one or more embodiments, the subject selection system utilizes one or more merging algorithms to determine whether to merge various bounding boxes. The subject selection system generates separate region masks for the finalized bounding boxes and processes the separate region masks utilizing the mask refinement neural network. Furthermore, the subject selection system combines the resulting refined region masks to generate a final mask for the digital image.

Conventional systems that provide image processing for digital images often utilize machine-learning segmentation to identify and extract semantic information from the digital images. Specifically, some segmentation neural networks attempt to break a digital image into separate parts with semantic information that indicates separate objects based on specific semantic concepts. Although many existing systems utilize image segmentation to perform various image segmentation tasks and generate masks for various objects in digital images, these conventional systems are often inaccurate due the often complex nature of many digital images. More specifically, high frequency details, soft boundaries, and the variability of objects within and across digital images often makes it difficult for many segmentation neural networks to accurately detect object boundaries.

Additionally, many conventional systems are inefficient due to using large neural networks (e.g., with many parameters and/or resource requirements) to perform image segmentation and editing tasks. For instance, some conventional systems require the use of several large segmentation neural networks to perform different image segmentation tasks on a single digital image. Thus, these conventional systems are cumbersome because they perform certain image processing (e.g., encoding/decoding) operations each time they perform a separate image segmentation task, resulting in significant processing time and computing resources. Some conventional systems attempt to overcome these inefficiencies by trading accuracy for improved efficiency, resulting in lower quality image segmentations and errors in image editing operations.

Furthermore, some conventional systems use processes that involve single-stage operations for generating masks for digital images with varied image content, from many objects to few objects. Because the conventional systems utilize segmentation neural networks that process an entire image, these systems typically result in processing certain objects at low resolution, especially when the objects occupy only a small part of the image. Additionally, the low resolution outputs are often a result of size limitations on the inputs to the segmentation neural networks. Other conventional systems utilize additional neural networks to refine or modify coarse details in initial masks, but these conventional systems are often unable to capture certain fine details without a trimap segmentation of the images. Thus, these multi-stage conventional systems require additional data, processes, and/or models that are often unavailable for use in segmenting many digital images.

Additionally, some conventional systems provide image segmentation that allows for identification and selection of different objects in a single image. Although such conventional systems provide improved customization of image editing operations on digital images, these conventional systems also typically involve the use of many different neural networks (e.g., as many as six different models or more) in sequence and/or in parallel to provide these benefits. This introduces increased latency in the training and inference pipelines and are difficult to implement on certain types of devices (e.g., mobile devices). Furthermore, even with the high number of models, these conventional systems often produce inaccurate results in image segmentations, such as by partially segmenting objects or failing to recognize certain fine details of objects or to accurately separate different objects in digital images.

The mask generation system provides a number of improvements in computing systems that segment digital images for various image editing operations. For example, the mask generation system utilizes a pipeline including a plurality of systems for efficiently performing multi-task segmentation operations and selective refinement. For instance, the mask generation system utilizes a segmentation neural network to perform a plurality of multi-task segmentation operations. In contrast to conventional systems that require the use of completely separate models to perform different types of image segmentation tasks, the mask generation system utilizes a single model that includes a plurality of query decoder neural networks to perform separate segmentation operations.

Additionally, by combining the separate query decoder neural networks into a single model, the mask generation system improves accuracy and consistency of image segmentation operations. Specifically, the mask generation system uses a single image encoder (and in some cases a single pixel decoder) to extract features from a digital image and generate mask features for use in a plurality of image segmentation masks (e.g., object segmentation masks corresponding to one or more objects in a digital image). In contrast to conventional systems that rely on a plurality of separate models to perform different image segmentation tasks, the mask generation system shares information across the various image segmentation tasks by using the same features extracted from the digital image. Thus, the mask generation system improves consistency of the results from executing a plurality of different image segmentation tasks by leveraging the shared information for each of the tasks.

Furthermore, the mask generation system trains and utilizes a refinement to accurately and efficiently refine coarse details in one or more initial masks generated for a digital image. In particular, the mask generation system trains a mask refinement neural network to refine uncertain portions of digital images via a synthetic training dataset including simulated masks and coarse masks. In contrast to conventional systems that require additional image data (e.g., trimaps) to refine coarse masks, the mask generation system trains a refinement neural network to refine coarse details based only on a digital image and an initial mask. For example, the mask generation system generates simulated masks by modifying ground-truth masks via operations such as synthetically filling holes and/or downscaling/upscaling at random sizes. Additionally, the mask generation system utilizes a plurality of different point-sampling operations to determines losses, which trains the mask refinement neural network to focus on more challenging areas (e.g., uncertain regions) of coarse masks.

In addition, the mask generation system improves accuracy and efficiency of computing systems that perform image segmentation and masking by selectively refining regions of digital images based on connected regions of base masks. For example, in contrast to conventional systems that perform mask refinement on entire base masks, the mask generation system identifies specific regions in a digital image to refine separately via a mask refinement neural network. Specifically, the mask generation system detects separate connected regions of a base mask and generates region masks based on bounding boxes corresponding to the separate connected regions. By processing each of the region masks individually via the mask refinement neural network and recombining the refined region masks, the mask generation system reduces resources required to refine unnecessary portions of the base mask. In some embodiments, the mask generation system also improves efficiency by dynamically merging bounding boxes to fit within mask refinement constraints (e.g., according to user preferences or resource limitations).

Furthermore, the mask generation system 102 provides improved accuracy by refining specific regions of a base mask. In contrast to conventional systems that refine an entire mask, the mask generation system focuses mask refinement operations on smaller, important portions of a base mask. Accordingly, the mask generation system provides refinement operations that generate high resolution and high edge quality in the individual region masks for combining into a final mask. The mask generation system thus provides improved details in uncertain regions from only the base mask by separating the base mask into separate connected regions.

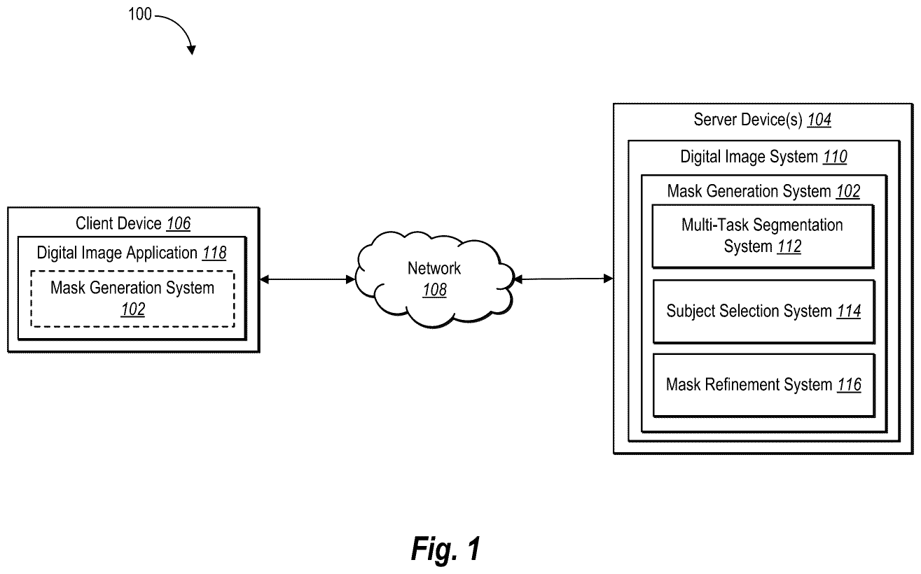

Turning now to the figures, FIG. 1 includes an embodiment of a system environment 100 in which a mask generation system 102 is implemented. In particular, the system environment 100 includes server device(s) 104 and a client device 106 in communication via a network 108. Moreover, as shown, the server device(s) 104 include a digital image system 110, which includes the mask generation system 102. Furthermore, in some embodiments, the mask generation system 102 includes a multi-task segmentation system 112, a subject selection system 114, and a mask refinement system 116. Additionally, the client device 106 includes a digital image application 118, which optionally includes the digital image system 110 (or the mask generation system 102).

As shown in FIG. 1, the client device 106 or the server device(s) 104 include or host the digital image system 110. The digital image system 110 includes, or is part of, one or more systems that implement digital image generation or editing operations. For example, the digital image system 110 provides tools for generating or editing digital images. To illustrate, the digital image system 110 communicates with the client device 106 via the network 108 to provide the tools for display and interaction via the digital image application 118 at the client device 106. Additionally, in some embodiments, the digital image system 110 receives requests to access digital image data stored (e.g., at the server device(s) 104 or at another device such as a database) and/or requests to store digital image data. In some embodiments, the digital image system 110 receives interaction data for viewing or performing various image processing operations and provides the results of the interaction data (e.g., generated digital image data) for display via the digital image application 118 or to a third-party system. In additional embodiments, the digital image system 110 provides tools for generating data (e.g., training data) for various downstream operations (e.g., training various neural networks).

According to one or more embodiments, the digital image system 110 utilizes the mask generation system 102 to edit or otherwise process digital images. In particular, the mask generation system 102 generates masks for digital images based on semantic information extracted from the digital images. For example, the mask generation system 102 utilizes the multi-task segmentation system 112 to execute one or more image segmentation tasks for generating one or more masks for a digital image. Additionally, the mask generation system 102 utilizes the subject selection system 114 to identify specific portions of masks generated by the multi-task segmentation system 112 for refinement (e.g., by generating region masks of the one or more generated masks). In one or more embodiments, the mask generation system 102 utilizes the mask refinement system 116 to train a mask refinement neural network by generating simulated masks and determining losses via point-sampling operations. The mask refinement system 116 also utilizes the trained mask refinement neural network to refine masks (e.g., region masks). Accordingly, the mask generation system 102 generates masks via various operations utilizing the multi-task segmentation system 112 and/or the subject selection system 114 and provides the results to the client device 106 (e.g., via the digital image application 118).

As illustrated in FIG. 1, the mask generation system 102 is implemented on the client device 106 or on the server device(s) 104. In particular, in some implementations, the mask generation system 102 on the server device(s) 104 supports the mask generation system 102 on the client device 106. For instance, the server device(s) 104 generates or obtains the mask generation system 102 for the client device 106 (e.g., as part of a software application or suite). The server device(s) 104 provides the mask generation system 102 to the client device 106 for performing digital image editing processes at the client device 106. In other words, the client device 106 obtains (e.g., downloads) the mask generation system 102 from the server device(s) 104. At this point, the client device 106 is able to utilize the mask generation system 102 to edit digital images independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the mask generation system 102 being implemented by a particular component and/or device within the system environment 100, the mask generation system 102 is implemented, in whole or in part, by other computing devices and/or components in the system environment 100. For example, in some embodiments, the server device(s) 104 include or host the digital image system 110 and/or the mask generation system 102.

To illustrate, in one or more embodiments, the mask generation system 102 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to view information for image editing tasks and, in response, the mask generation system 102 or the digital image system 110 on the server device(s) 104 performs operations to edit or process digital images. The server device(s) 104 provide the output or results of the operations to the client device 106.

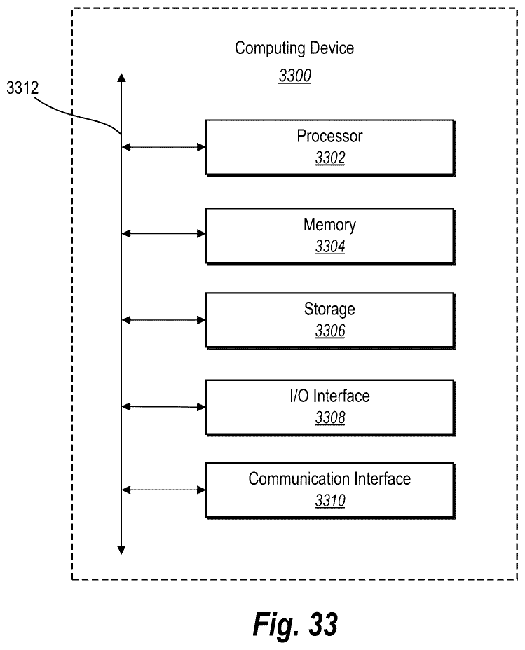

In one or more embodiments, the server device(s) 104 include a variety of computing devices, including those described below with reference to FIG. 33. For example, the server device(s) 104 include one or more servers for storing and processing data associated with image editing processes. In some embodiments, the server device(s) 104 also include a plurality of computing devices in communication with each other, such as in a distributed storage environment. In some embodiments, the server device(s) 104 include a content server. The server device(s) 104 also optionally include an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 33). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, generating, and editing digital images. In some embodiments, the client device 106 also performs functions for generating, capturing, or accessing data to provide to the digital image system 110 and the mask generation system 102 in connection with editing digital images. For example, the client device 106 communicates with the server device(s) 104 via the network 108 to provide information (e.g., user interactions) associated with digital images. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 33.

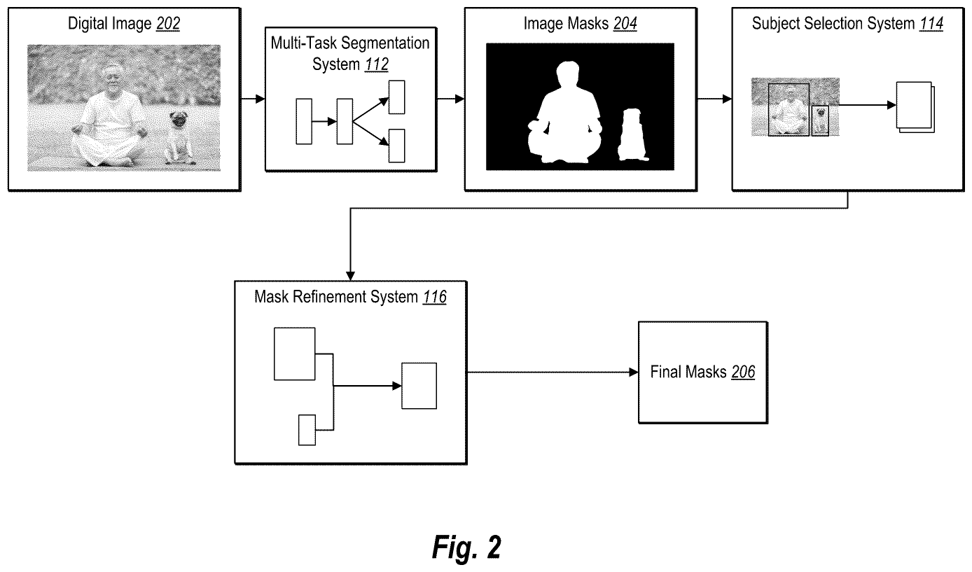

As mentioned, the mask generation system 102 utilizes a pipeline including a plurality of additional systems to generate and refine masks for digital images. For example, FIG. 2 illustrates an overview of the pipeline of the mask generation system 102 including the multi-task segmentation system 112, the subject selection system 114, and the mask refinement system 116. Specifically, FIG. 2 illustrates that the mask generation system 102 utilizes the systems to generate one or more masks for a digital image via one or more image segmentation tasks and selectively refine portions of the mask(s).

As illustrated in FIG. 2, in one or more embodiments, the mask generation system 102 determines a digital image 202 including various objects. For example, the digital image 202 includes a digital photograph of a real-world scene. In other examples, the digital image 202 includes synthetically generated content. In one or more embodiments, the mask generation system 102 determines the digital image 202 in connection with a request to perform one or more image editing operations on the digital image 202, such as object editing operations, foreground/background editing operations, or other operations that involve segmenting portions of the digital image 202.

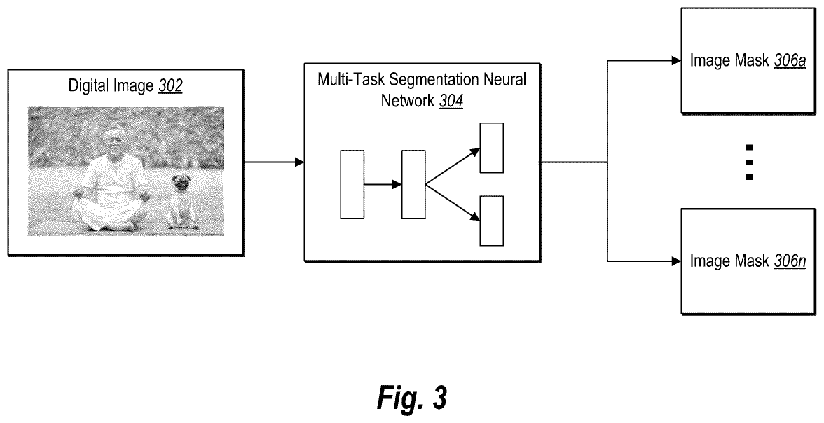

FIG. 2 illustrates that the mask generation system 102 utilizes the multi-task segmentation system 112 to generate image masks 204 for the digital image 202. In particular, the multi-task segmentation system 112 includes a single model that performs a plurality of separate image segmentation tasks on the digital image 202. For example, the multi-task segmentation system 112 includes a multi-task segmentation neural network that uses shared feature information to perform a plurality of image segmentation tasks on the digital image 202, such as segmenting different portions of the digital image 202 for different purposes. FIGS. 3-12 and the corresponding description provide additional detail related to the operations of the multi-task segmentation system 112.

Additionally, FIG. 2 illustrates that the mask generation system 102 generates image masks 204 for the digital image 202. Specifically, the mask generation system 102 generates one or more alpha mattes and/or one or more binary masks for one or more objects in the digital image 202. For instance, the mask generation system 102 uses the multi-task segmentation system 112 to generate the image masks 204 based on one or more segmentations generated via the image segmentation tasks. Thus, the image masks 204 include values indicating boundaries of the one or more objects or specific portions of the one or more objects for various image editing operations.

In one or more embodiments, the image masks 204 include one or more coarse masks generated for the digital image 202. For example, the image masks 204 include coarse (e.g., approximated) details for boundaries of the one or more objects in the digital image 202. Accordingly, the mask generation system 102 utilizes the subject selection system 114 and the mask refinement system 116 to refine the coarse details in the image masks 204.

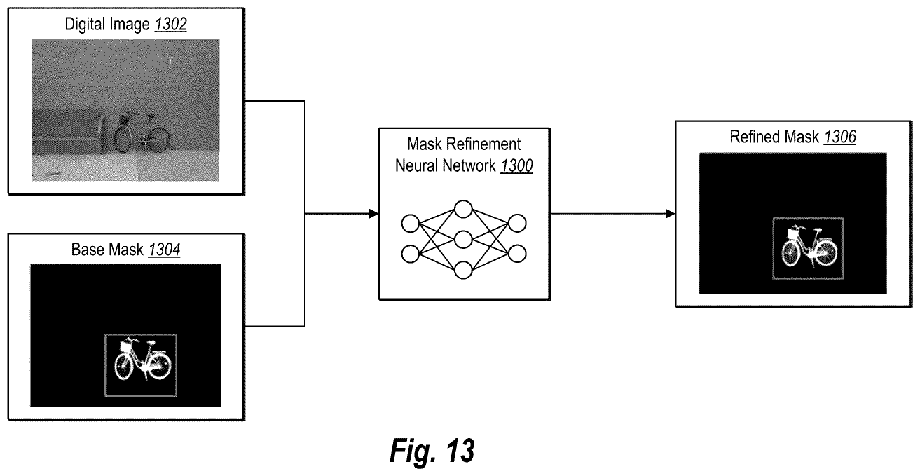

Specifically, in one or more embodiments, the mask generation system 102 utilizes the subject selection system 114 to identify connected regions in the digital image 202. For instance, the subject selection system 114 determines bounding boxes for separate connected regions (e.g., representing visually separated objects) in the digital image 202 and generates region masks for refinement. Additionally, as part of the region mask generation processes, the subject selection system 114 determines which image masks 204 to keep and refine via various mask scores, since the multi-task segmentation system 112 possibly generates image masks 204 with varying qualities and for various subjects in the digital image 202. FIGS. 13-20C and the corresponding description provide additional detail related to selectively determining portions of digital images for refining.

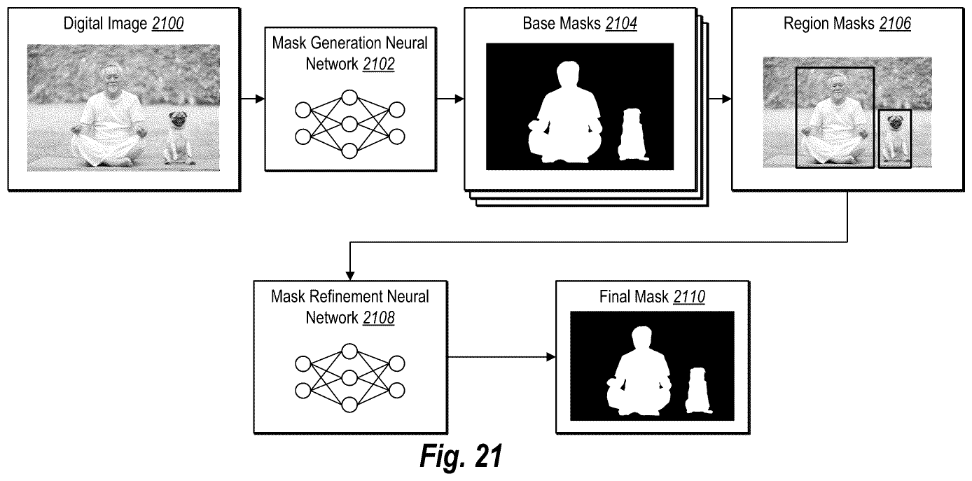

In response to determining specific region masks for portions of the digital image 202 (e.g., for separate objects), the mask generation system 102 utilizes a mask refinement system 116 to refine the image masks 204. In particular, the mask refinement system 116 refines the region masks generated by the subject selection system 114 in separate refinement operations. Additionally, the mask refinement system 116 combines the refined region masks from a given base mask to generate a final mask. Thus, the mask generation system 102 generates final masks 206 from the image masks 204 generated by the multi-task segmentation system 112. FIGS. 21-28 and the corresponding description provide additional detail related to refining image masks via a mask refinement neural network, as well as detail related to training the mask refinement neural network.

As mentioned, in one or more embodiments, the mask generation system 102 utilizes the multi-task segmentation system 112 to perform various image segmentation tasks. FIG. 3 illustrates an overview of the multi-task segmentation system 112 utilizing a multi-task segmentation neural network that performs a plurality of image segmentation tasks on a digital image to generate a plurality of separate image masks. More specifically, the multi-task segmentation system 112 utilizes a single model to perform the different image segmentation tasks.

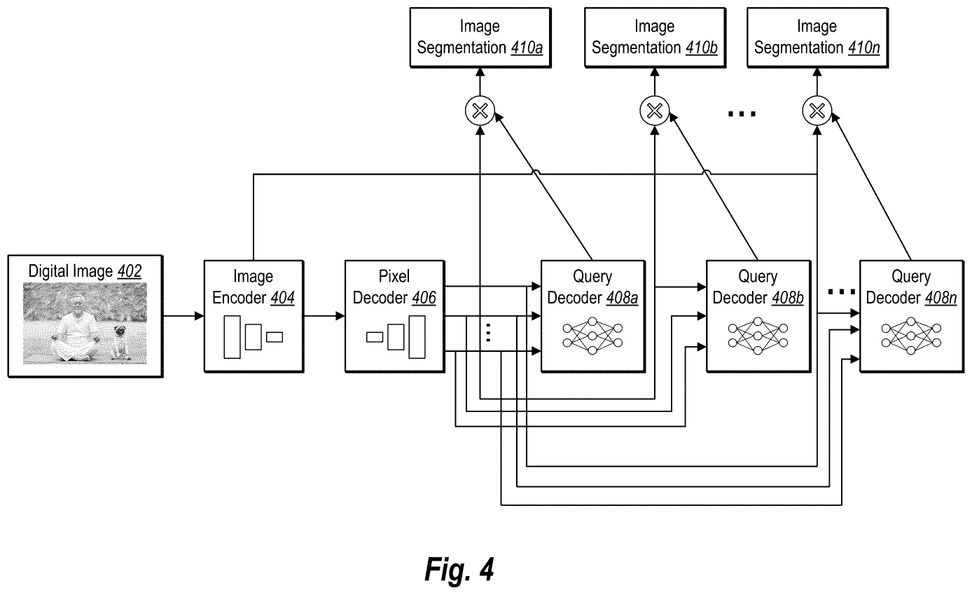

As illustrated, the multi-task segmentation system 112 processes a digital image 302 utilizing a multi-task segmentation neural network 304. As described in more detail below with respect to FIGS. 4-9, the multi-task segmentation neural network 304 includes an encoder/decoder architecture that uses shared features extracted from the digital image 302 to perform a plurality of separate image segmentation tasks. For instance, in various embodiments, the multi-task segmentation neural network 304 includes a plurality of query decoders with learned queries to perform the separate image segmentation tasks based on a single set of extracted features from the digital image 302.

Additionally, as illustrated in FIG. 3, the multi-task segmentation system 112 utilizes the segmentation outputs of the multi-task segmentation neural network 304 to generate a plurality of image masks 306a-306n. For example, the image masks 306a-306n mask different portions of the digital image 302, such as by masking separate objects or groups of objects. Furthermore, in one or more embodiments, the image masks 306a-306n include binary masks, alpha mattes (e.g., with alpha values for blended boundary regions), and/or a combination of one or more binary masks and one or more alpha mattes.

In one or more embodiments, as mentioned, a multi-task segmentation neural network includes an encoder/decoder architecture that shares features extracted from a digital image for performing a plurality of image tasks. FIG. 4 illustrates a diagram of an example multi-task segmentation neural network for segmenting a digital image via a plurality of separate image segmentation tasks. In particular, the multi-task segmentation neural network shares extracted information across the separate image segmentation tasks for efficiency and to provide consistence in the resulting segmentations.

In one or more embodiments, a neural network includes a computer representation that is tuned (e.g., trained) based on inputs to approximate unknown functions. For instance, a neural network includes one or more layers or artificial neurons that approximate unknown functions by analyzing known data at different levels of abstraction. In some embodiments, a neural network includes one or more neural network layers including, but not limited to, a convolutional neural network, a recurrent neural network, a transformer-based neural network, or a feedforward neural network. To illustrate, the multi-task segmentation neural network includes a plurality of convolutional neural network layers (e.g., in an encoder neural network and/or a decoder neural network). In one or more embodiments, the multi-task segmentation neural network includes one or more transformer neural networks.

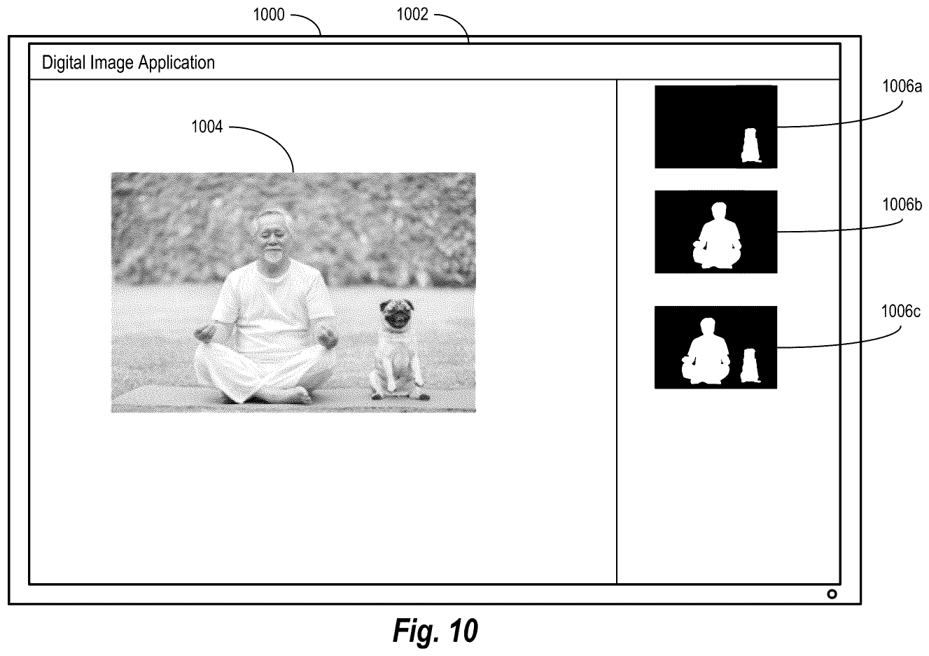

As illustrated in FIG. 4, the multi-task segmentation system 112 processes a digital image 402 including one or more objects. Specifically, the multi-task segmentation system 112 utilizes the multi-task segmentation neural network to perform a plurality of segmentation tasks on the digital image 402. For example, the multi-task segmentation system 112 performs image segmentation tasks such as parsing bodies in the digital image 402, predicting masks for a salient portion (e.g., a main subject) of the digital image 402, detecting specific object types, etc. Furthermore, in one or more embodiments, the multi-task segmentation system 112 performs image segmentation tasks for various additional image processing operations including, but not limited to, object detection, depth prediction, surface normal prediction, and edge detection (e.g., by providing multi-modal segmentation information for downstream operations). In connection with performing the separate image segmentation tasks, the multi-task segmentation system 112 generates various image masks to present for display and/or interaction (e.g., as described in relation to FIG. 10).

As illustrated in FIG. 4, the multi-task segmentation neural network of the multi-task segmentation system 112 includes an image encoder 404 to extract features from the digital image 402. For instance, the image encoder 404 includes various neural network layers (e.g., convolutional neural network layers) that encode features of pixels of the digital image 402 at a plurality of different resolutions. To illustrate, the image encoder 404 includes a plurality of layers to successively encode features of the digital image 402 to a latent space at the different resolutions.

In one or more embodiments, the multi-task segmentation system 112 also includes a pixel decoder 406 to determine mask features based on the encoded features from the image encoder 404. Specifically, the pixel decoder 406 includes a plurality of neural network layers (e.g., convolutional neural network layers) that decode encoded features of pixels of the digital image 402 while also upsampling the decoded features at a plurality of resolutions. In one or more embodiments, the pixel decoder 406 generates a set of mask features corresponding to the digital image 402 for use in generating one or more image masks.

In response to generating the mask features utilizing the pixel decoder 406, the multi-task segmentation neural network provides the mask features to a plurality of query decoders 408a-408n. In particular, the plurality of query decoders 408a-408n include various query-based neural networks for converting the mask features from the pixel decoder 406 to a plurality of image segmentations 410a-410n. For example, the query decoders 408a-408n are separate decoder neural networks that are each trained to perform a particular image segmentation task and generate predicted mask embedding vectors based on the mask features from the pixel decoder 406. To illustrate, the query decoders 408a-408n receive, as inputs, mask features from a plurality of different layers of the pixel decoder 406 (e.g., at a plurality of different resolutions).

Furthermore, as illustrated in FIG. 4, the multi-task segmentation neural network combines the predicted mask embedding vectors from the query decoders 408a-408n with high-resolution mask features generated by the pixel decoder 406 via dot-product operations to generate the image segmentations 410a-410n. As previously indicated, the multi-task segmentation neural network thus generates the image segmentations 410a-410n to include various image masks corresponding to different objects, object groups, object types, etc., depending on the specific query decoders 408a-408n. To illustrate, a first image segmentation 410a includes a first mask based on a first image segmentation task, and a second image segmentation 410b includes a second mask based on a second image segmentation task. Additionally, in various embodiments, the image segmentations 410a-410n include binary masks, alpha mattes, and/or a combination of binary masks and alpha mattes. In one or more embodiments, an image mask includes an object segmentation mask, which includes a masked region corresponding to a specific object or group of objects in a digital image.

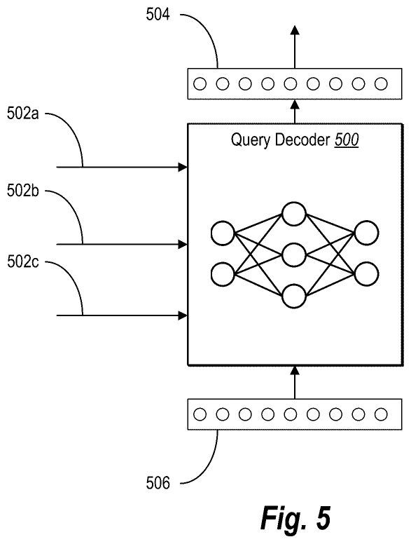

FIG. 5 illustrates an example of a query decoder 500 in the multi-task segmentation neural network of FIG. 4. As illustrated, the query decoder 500 receives a set of mask features from a pixel decoder at a plurality of resolutions. For instance, the set of mask features includes first mask features 502a at a first resolution, second mask features 502b at a second resolution, and third mask features 502c at a third resolution. Although FIG. 5 illustrates only three separate mask features at three resolutions, in alternative embodiments, the query decoder 500 receives N mask features.

In one or more embodiments, the query decoder 500 includes a transformer-based decoder neural network that uses the mask features from the pixel decoder at the plurality of resolutions to generate a predicted mask embedding vector 504 for a particular image segmentation task. Specifically, the query decoder 500 generates the predicted mask embedding vector 504 based on a set of learnable queries 506. In one or more embodiments, the query decoder 500 includes a box prediction head that predicts bounding box coordinates of an object (or region) in a digital image in connection with generating image masks for the digital image. In alternative embodiments, the query decoder 500 includes a mask embedding prediction head instead of a box prediction head. Furthermore, in one or more embodiments, the query decoder 500 utilizes masked or unmasked cross-attention to generate the predicted mask embedding vector 504, according to a particular image segmentation task.

In additional embodiments, the query decoder 500 includes parameters trained for a particular image segmentation task. Specifically, the multi-task segmentation system 112 utilizes a training dataset to train the query decoder 500 by modifying parameters of the query decoder 500 for the particular image segmentation task. In one or more embodiments, the multi-task segmentation system 112 utilizes other query decoder architectures for one or more query decoders and/or training datasets for specific image segmentation tasks and/or multi-modal tasks involving non-vision modalities such as language. Thus, in various embodiments, the query decoder 500 is trained to perform a particular image segmentation task based only on image data or a multi-modal task based on image data and text data (e.g., by generating the predicted mask embedding vector 504 based on the mask features and a text prompt). Accordingly, as an example, the query decoder 500 performs a particular image segmentation task to segment a particular object in a digital image with specific attributes based on a text prompt (e.g., “person wearing blue shirt”).

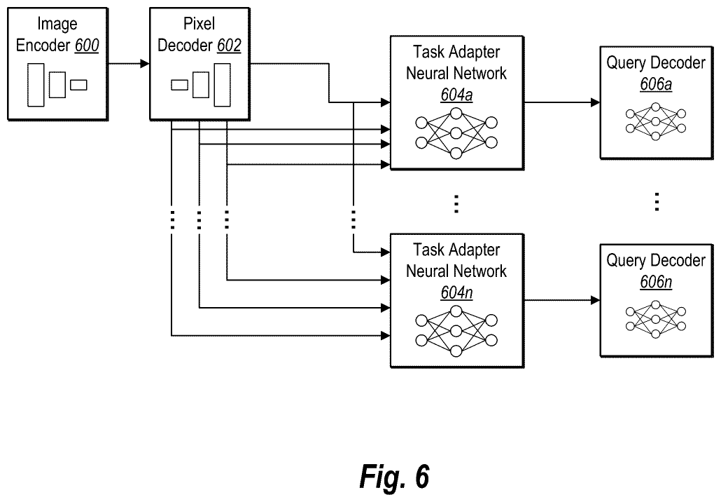

In one or more additional embodiments, the multi-task segmentation system 112 utilizes a multi-task segmentation neural network that includes task adapter neural networks for adapting shared information to specific image segmentation tasks. FIG. 6 illustrates an example of a multi-task segmentation neural network including task adapter neural networks. Specifically, the task adapter neural networks modify the shared information for better accuracy with each image segmentation task while also maintaining consistency across the separate image segmentation tasks.

As illustrated in FIG. 6, the multi-task segmentation neural network includes an image encoder 600 and a pixel decoder 602. More specifically, the multi-task segmentation neural network includes only one image encoder and only one pixel decoder. Thus, the multi-task segmentation system 112 utilizes the image encoder 600 to encode features and the pixel decoder 602 to generate mask features that are shared across a plurality of image segmentation tasks via a plurality of task branches of the multi-task segmentation neural network. In one or more embodiments, utilizing a single image encoder and a single pixel decoder shares computationally intensive aspects of image processing operations to reduce the overall resource requirements of the separate image segmentation tasks.

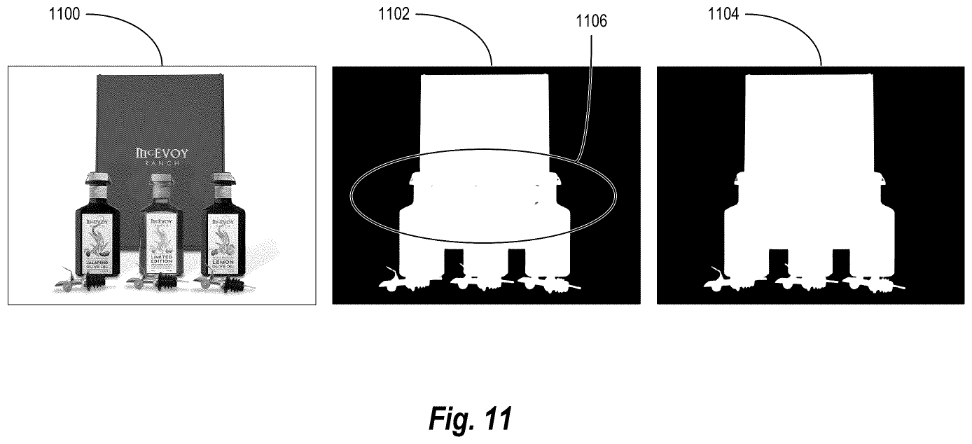

In one or more embodiments, the multi-task segmentation neural network includes a plurality of task adapter neural networks 604a-604n that receive the mask features from the pixel decoder 602. Additionally, the multi-task segmentation neural network includes a plurality of query decoders 606a-606n for the separate image segmentation tasks that receive modified mask features from the task adapter neural networks 604a-604n. In one or more embodiments, the task adapter neural networks 604a-604n provide a buffer between the pixel decoder 602 and the query decoders 606a-606n to prevent the separate image segmentation tasks from interfering with or influencing one another (e.g., during training and inference of the multi-task segmentation neural network). FIG. 11 illustrates an example of such interference across a plurality of image segmentation tasks.

According to one or more embodiments, the multi-task segmentation system 112 utilizes the task adapter neural networks 604a-604n to modify mask features generated by the pixel decoder 602, resulting in modified mask features adapted to the specific image segmentation tasks. For example, a first task adapter neural network 604a generates first modified mask features for a first image segmentation task, and an nth task adapter neural network 604n generates nth modified mask features for an nth image segmentation task. Thus, the multi-task segmentation neural network inputs the first modified mask features to a first query decoder 606a corresponding to the first image segmentation task. Furthermore, the multi-task segmentation neural network inputs the nth modified mask features to an nth query decoder 606n corresponding to the nth image segmentation task.

In one or more embodiments, a task adapter neural network includes one or more neural network layers that uses an output of the pixel decoder 602 (e.g., a set of mask features) as an initial input and N intermediate layers of the pixel decoder 602 to generate modified mask features, as illustrated in FIG. 6. For instance, a task adapter neural network includes a series of neural network layers (e.g., cross attention layers with feedforward network layers) that attach to the N intermediate layers of the pixel decoder 602 to successively refine the mask features. In one or more embodiments, the task adapter neural network includes channel and token mixers with a predetermined rank (e.g., 64). By utilizing a separate task adapter neural network to modify the output of the pixel decoder 602 for a particular image segmentation task, the multi-task segmentation system 112 is able to efficiently optimize the separate portions of the multi-task segmentation neural network for the separate image segmentation tasks while limiting interference between the tasks.

Specifically, the multi-task segmentation system 112 jointly trains the task adapter neural networks and their corresponding query decoders with the pixel decoder 602 and the image encoder 600 according to the separate image processing tasks. For example, the multi-task segmentation system 112 utilizes one or more training datasets for the image processing tasks to jointly train layers of the multi-task segmentation neural network. Additionally, in one or more embodiments, the multi-task segmentation system 112 jointly optimizes parameters of the image encoder 600, the pixel decoder 602, the task adapter neural networks 604a-604n, and the query decoders 606a-606n.

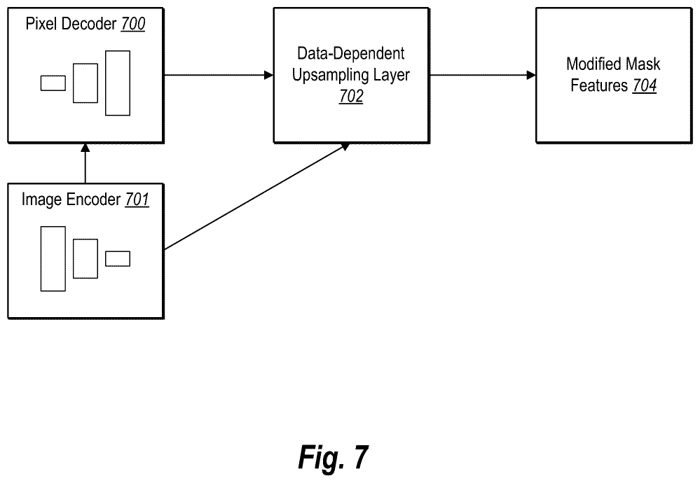

In one or more embodiments, the multi-task segmentation system 112 utilizes enhanced upsampling of mask features generated by a pixel decoder to improve accuracy of image segmentations generated by a multi-task segmentation neural network. FIG. 7 illustrates an example of an architecture including a pixel decoder 700 and a data-dependent upsampling layer 702 to generate modified mask features 704 for a digital image. Specifically, the multi-task segmentation system 112 modifies an output of the pixel decoder 700 to improve the fidelity of the mask features provided to query decoders for various image segmentation tasks.

In particular, as previously described, the pixel decoder 700 generates mask features from features extracted by an image encoder 701. In one or more embodiments, in connection with upsampling feature maps generated by the pixel decoder (e.g., the second largest feature maps), the multi-task segmentation system 112 utilizes the data-dependent upsampling layer 702 to upsample the feature maps and merge the upsampled feature maps with the high-resolution features generated by the image encoder 701. For example, the data-dependent upsampling layer 702 dynamically generates sampling points for upsampling the feature maps from the pixel decoder 700 (e.g., instead of bilinear interpolation). To illustrate, the data-dependent upsampling layer 702 generates a sampling set via a sampling point generator to re-sample an input feature and where the sampling set is the sum of a generated offset (e.g., based on a linear layer) and an original grid position of a sampling grid. In additional embodiments, the data-dependent upsampling layer 702 uses a dynamic scope factor in which the data-dependent upsampling layer 702 generates a scope factor and uses the scope factor to modulate the offset.

In response to upsampling the feature maps utilizing the data-dependent upsampling layer 702, the multi-task segmentation system 112 merges the upsampled features with the high-level features from the image encoder 701 to generate the modified mask features 704. Additionally, as previously described, the multi-task segmentation system 112 utilizes mask features generated via a pixel decoder to perform a variety of image segmentation tasks. Thus, in the embodiment of FIG. 7, the multi-task segmentation system 112 provides the modified mask features 704 to the corresponding query decoders (or to the corresponding task adapter neural networks) for performing the respective image segmentation tasks.

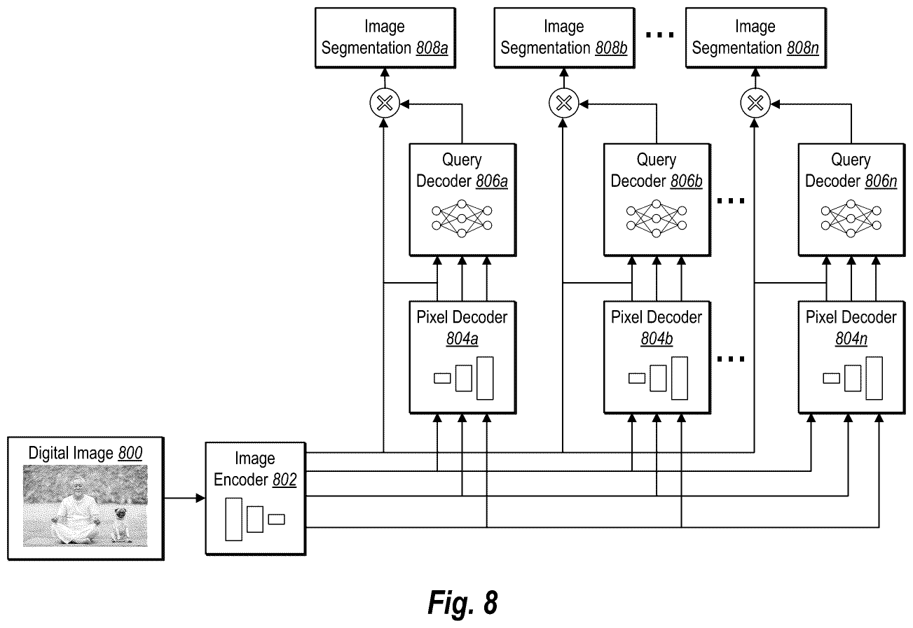

Although FIGS. 4-6 illustrate a specific embodiment of a multi-task segmentation neural network, in alternative embodiments, the multi-task segmentation system 112 utilizes a multi-task segmentation neural network with a different architecture. Specifically, FIG. 8 illustrates an example of a multi-task segmentation neural network that uses shared feature information from a single image encoder and a plurality of pixel decoders. Furthermore, FIG. 8 illustrates that the pixel decoders pair with corresponding query decoders to perform image segmentation operations.

As illustrated in FIG. 8, a multi-task segmentation neural network processes a digital image 800 by extracting features via an image encoder 802. As mentioned, the multi-task segmentation neural network utilizes a single image encoder to generate a shared set of features representing the digital image 800 in a latent space. Rather than utilizing a single pixel decoder, as in FIG. 4, the multi-task segmentation neural network of FIG. 8 includes a plurality of pixel decoders 804a-804n corresponding to the separate image processing tasks. For example, the multi-task segmentation neural network inputs the extracted features from the image encoder 802 to each of the pixel decoders 804a-804n.

Additionally, the pixel decoders 804a-804n generate separate sets of mask features that are inputs to the query decoders 806a-806n for the separate image segmentation tasks. Specifically, as illustrated, the multi-task segmentation neural network utilizes the query decoders 806a-806n to generate separate image segmentations 808a-808n for the separate image segmentation tasks based on the separate mask features generated by the pixel decoders 804a-804n while sharing image encoding information extracted by the image encoder 802. In one or more embodiments, the multi-task segmentation system 112 utilizes the architecture of FIG. 8 to improve the accuracy of the image segmentations 808a-808n. In some embodiments, the multi-task segmentation system 112 uses the architecture of FIG. 4 or the architecture of FIG. 8 (e.g., a single pixel decoder or a plurality of pixel decoders) in response to a selection by a user or in response to a determination of available computing resources.

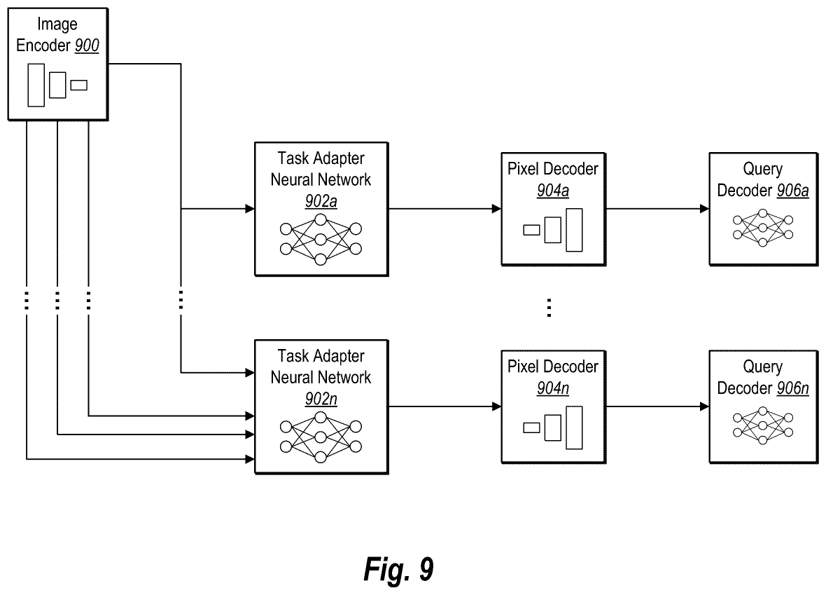

In one or more embodiments, the multi-task segmentation system 112 utilizes task adapter neural networks for modifying encoded features to input to a plurality of pixel encoders (e.g., as in FIG. 8). For example, FIG. 9 illustrates an example architecture of a multi-task segmentation neural network including a plurality of task adapter neural networks that modify the extracted features for a plurality of separate image processing tasks utilizing the architecture of FIG. 8. As illustrated, the multi-task segmentation neural network includes an image encoder 900 to generate a set of extracted features representing a digital image at a plurality of resolutions.

In one or more embodiments, the multi-task segmentation neural network includes a plurality of task adapter neural networks 902a-902n to modify the extracted features based on N intermediate layers of the image encoder 900 (e.g., at the different resolutions). Accordingly, the task adapter neural networks 902a-902n generate sets of modified extracted features to provide as inputs to corresponding pixel decoders 904a-904n. In one or more embodiments, the pixel decoders 904a-904n generate sets of mask features based on the corresponding sets of modified extracted features and provide the sets of mask features to query decoders 906a-906n to perform the separate image segmentation tasks and generate a plurality of image segmentations.

FIG. 10 illustrates an example graphical user interface for displaying a plurality of image masks based on a plurality of separate image segmentation tasks. In particular, a client device 1000 displays a graphical user interface for a digital image application 1002 including tools for editing a digital image 1004. For example, the digital image application 1002 includes tools for segmenting and interacting with specific objects or regions in the digital image 1004.

In one or more embodiments, the client device 1000 detects a request to generate one or more image masks via a plurality of image segmentation tasks. In response to the request, the multi-task segmentation system 112 utilizes a multi-task segmentation neural network (e.g., as described previously) to perform the plurality of image segmentation tasks and generate one or more image masks. For instance, the image segmentation tasks are part of processes for generating separate image masks (e.g., a first image mask 1006a, a second image mask 1006b, and a third image mask 1006c). Alternatively, the image segmentation tasks are part of process for generating a single image mask via various separate operations. In one or more embodiments, the client device 1000 provides tools for interacting with the image mask(s) and displaying and editing information in the digital image 1004 based on the interactions with the image mask(s).

FIG. 11 illustrates a comparison of image masks generated for a digital image 1100. As previously mentioned, different image segmentation tasks have different purposes and use different processes to generate image segmentations. As an example, instance-aware segmentation tasks represent different object instances by respective image masks and therefore separate object instances along their boundaries. In other tasks such as foreground-background segmentation tasks, multiple objects are often included in a single segmentation mask.

FIG. 11 illustrates a first image mask 1102 generated for an instance-aware segmentation task without task adapter neural networks. FIG. 11 also illustrates a second image mask 1104 generated for the instance-aware segmentation task with task adapter neural networks. As illustrated, the first image mask 1102 generated without the task adapter neural networks includes errors at the boundaries of the individual foreground objects, while the second image mask 1104 generated with the task adapter neural networks corrected those errors. FIG. 11 also illustrates a region 1106 of the first image mask 1102 including various errors.

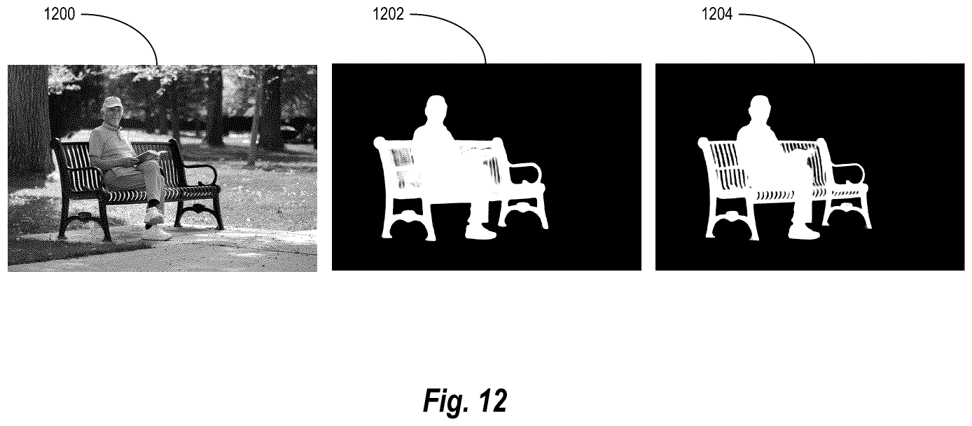

Furthermore, FIG. 12 illustrates a comparison of image masks generated for a digital image 1200 using different upsampling strategies for the pixel decoder. Specifically, FIG. 12 illustrates a first image mask 1202 generated using bilinear interpolation upsampling, and a second image mask 1204 generated using dynamically generated sampling points (e.g., using the data-dependent upsampling layer 702 of FIG. 7). As illustrated, utilizing dynamic point sampling improved the fine details of the bench in the second image mask 1204 relative to the first image mask 1202.

As mentioned, in one or more embodiments, the mask generation system 102 includes a mask refinement system 116 for refining coarse details of coarse/base masks generated via a mask generation neural network (e.g., the multi-task segmentation neural networks described previously). FIGS. 13-20C provide additional detail related to the operations of the mask refinement system 116 training and utilizing a mask refinement neural network for refining coarse mask details.

FIG. 13 illustrates an overview of a mask refinement process utilizing a mask refinement neural network 1300 to refine image masks for digital images. In particular, the mask refinement system 116 determines a digital image 1302 with a base mask 1304 including one or more masked portions corresponding to one or more objects in the digital image 1302. For example, as previously described, the mask generation system 102 utilizes a mask generation neural network (e.g., via the multi-task segmentation system 112) to generate one or more image masks for a digital image via one or more image segmentation tasks. In additional embodiments, the mask refinement system 116 determines the base mask 1304 via one or more other mask generation neural networks.

In one or more embodiments, the mask refinement system 116 utilizes the mask refinement neural network 1300 to modify one or more portions of the base mask 1304 to refine details at boundaries of masked regions. Specifically, in one or more embodiments, the mask generation system 102 generates an image masks including an initial process for generating a coarse mask (e.g., the base mask 1304) with a lower resolution. Because the base mask 1304 is a coarse mask, the base mask 1304 potentially includes errors at boundaries of masked regions due to blended/uncertain boundaries (e.g., hair or fur), fine details, or other image data that result in errors at boundaries of foreground regions or objects in the digital image 1302. Accordingly, the mask refinement system 116 utilizes the mask refinement neural network 1300 to generate a refined mask 1306 that refines details in the base mask 1304, such as by correcting errors in the base mask 1304 and/or increasing the resolution of the base mask 1304.

As described in more detail below, the mask refinement system 116 generates training data to train the mask refinement neural network 1300 to refine boundaries in base masks. In particular, the mask refinement system 116 utilizes the mask refinement neural network 1300 to generate a training dataset by modifying image masks of digital images via specific mask modification operations and optimize parameters of the mask refinement neural network 1300 to more accurately refine one or more portions of coarse masks.

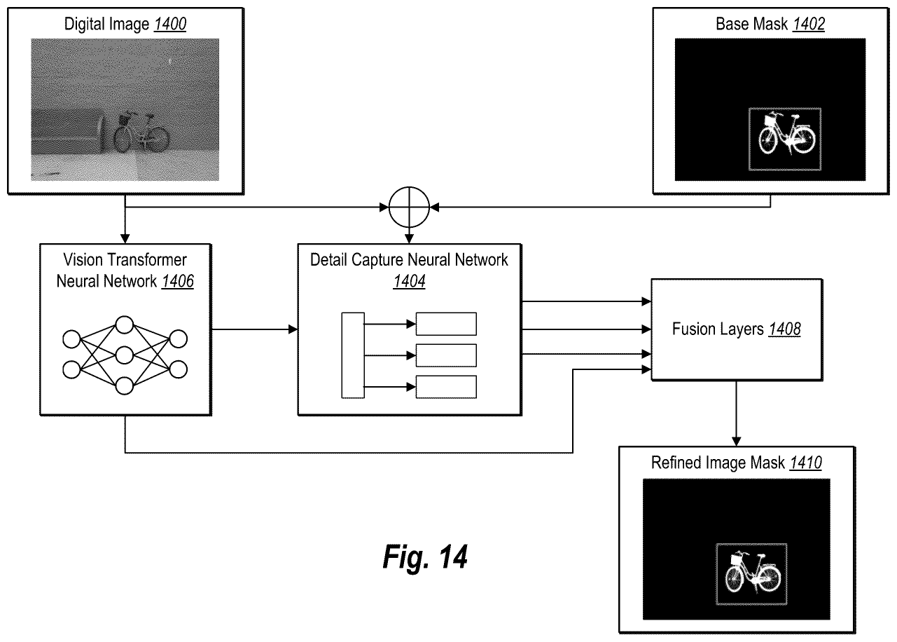

FIG. 14 illustrates an example architecture of a mask refinement neural network for refining an image mask. Specifically, as illustrated, the mask refinement system 116 utilizes the mask refinement neural network to refine details of a base mask 1402 for a digital image 1400. For example, the mask refinement neural network includes a detail capture neural network 1404, a vision transformer neural network 1406, and fusion layers 1408. Thus, in one or more embodiments, the mask refinement neural network includes a plurality of separate branches for processing the digital image 1400 and the base mask 1402 as inputs to modify the base mask 1402 and generate a refined image mask 1410.

In one or more embodiments, as illustrated, the mask refinement system 116 inputs the digital image 1400 and the base mask 1402 to the detail capture neural network 1404. In one or more embodiments, the mask refinement system 116 concatenates the digital image 1400 and the base mask 1402 to provide to the detail capture neural network 1404. For example, the detail capture neural network 1404 includes a stack of convolutional neural networks that generate a set of features at a plurality of different resolutions. To illustrate, the detail capture neural network 1404 uses the stack of three convolutional neural networks to generate features at three separate resolutions. The detail capture neural network 1404 captures fine-grained details of the digital image 1400 for use in refining the base mask 1402 based on correspondences between the digital image 1400 and the base mask 1402.

Additionally, in one or more embodiments, the mask refinement system 116 inputs only the digital image 1400 to the vision transformer neural network 1406. For instance, the vision transformer neural network 1406 includes a pre-trained neural network including a transformer-based encoder to extract features from the digital image 1400. Furthermore, the vision transformer neural network 1406 generates the features at an additional resolution different than the resolutions of the features generated by the detail capture neural network 1404. To illustrate, the resolution of the features generated by the vision transformer neural network 1406 have a lower resolution than the features generated by the detail capture neural network 1404.

As illustrated in FIG. 14, the mask refinement neural network includes the fusion layers 1408 to combine the features from the detail capture neural network 1404 and the vision transformer neural network 1406. Specifically, as illustrated, the mask refinement neural network uses the fusion layers 1408 to combine the higher resolution features generated based on the digital image 1400 and the base mask 1402 with the lower resolution features generated based on the digital image 1400. The fusion layers 1408 include one or more convolutional neural network layers to combine and decode the features to generate the refined image mask 1410.

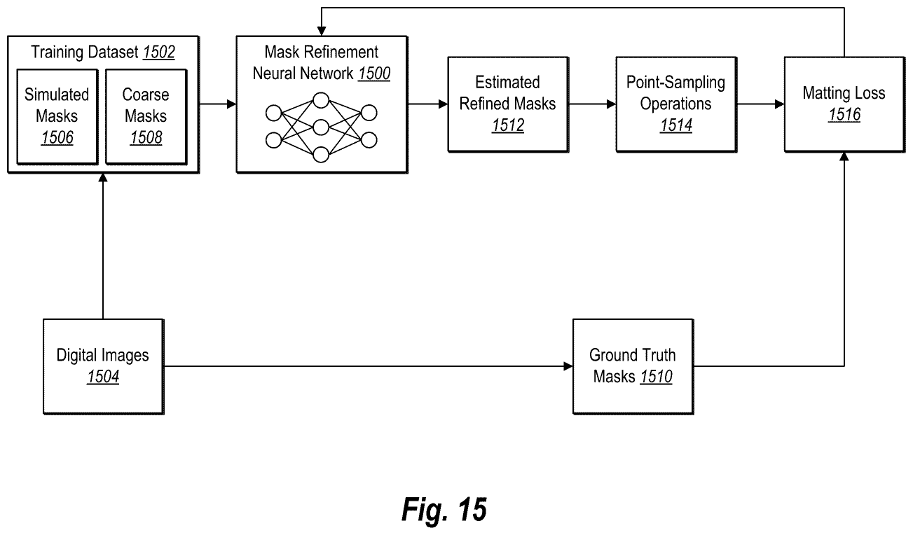

FIG. 15 illustrates an example diagram of the mask refinement system 116 training a mask refinement neural network 1500 utilizing a training dataset 1502 of various image masks corresponding to digital image 1504. For example, the training dataset 1502 includes simulated masks 1506, which include modified versions of ground-truth masks 1510 (e.g., ground-truth alpha mattes and/or ground-truth binary masks) of the digital images 1504. In one or more embodiments, the training dataset 1502 also includes coarse masks 1508 generated for the digital images 1504 utilizing a mask generation neural network. In one or more embodiments, the training dataset 1502 includes a plurality of triplets including: a digital image, an input mask (e.g., a simulated mask or a coarse mask), and a ground-truth mask. Additionally, in some embodiments, the triplets include annotation data such as a likelihood score representing a likelihood of a given mask (e.g., a simulated mask or a coarse mask) being preferred by a human.

As illustrated in FIG. 15, the mask refinement system 116 utilizes the mask refinement neural network 1500 to generate estimated refined masks 1512 from the training dataset 1502. Specifically, for each of the masks (e.g., the simulated masks 1506 and the coarse masks 1508), the mask refinement system 116 utilizes the mask refinement neural network 1500 to generate an estimated refined mask. For instance, the mask refinement neural network 1500 includes a set of initialized parameters (e.g., prior to training). Thus, the estimated refined masks 1512 include refined masks generated by the mask refinement neural network 1500 based on the initialized parameters.

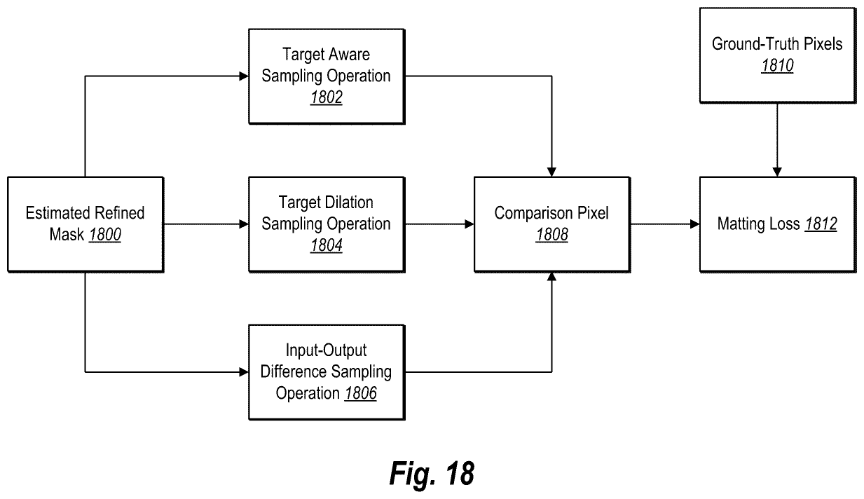

In one or more embodiments, in response to generating the estimated refined masks 1512, the mask refinement system 116 determines a loss associated with the estimated refined masks 1512 indicating differences between the estimated refined masks 1512 and the ground-truth masks 1510. For instance, as illustrated, the mask refinement system 116 utilizes point-sampling operations 1514 to sample points in the estimated refined masks 1512 for comparison to the ground-truth masks 1510. As described in more detail below with respect to FIG. 18, the point-sampling operations 1514 allows the mask refinement system 116 to accurately determine the loss (e.g., a matting loss 1516) between an estimated refined mask and its ground-truth mask without requiring a separate trimap while stabilizing training and focusing on challenging areas.

In one or more embodiments, in response to determining the matting loss 1516, the mask refinement system 116 trains the mask refinement neural network 1500 utilizing the matting loss 1516. Specifically, the mask refinement system 116 utilizes the matting loss 1516 to optimize parameters of the mask refinement neural network 1500 for reducing the differences between the estimated refined masks 1512 and the ground-truth masks 1510. For example, the mask refinement system 116 utilizes the matting loss 1516 to modify the parameters of the mask refinement neural network 1500, generates updated estimated refined masks, and determines an updated matting loss in a plurality of training steps.

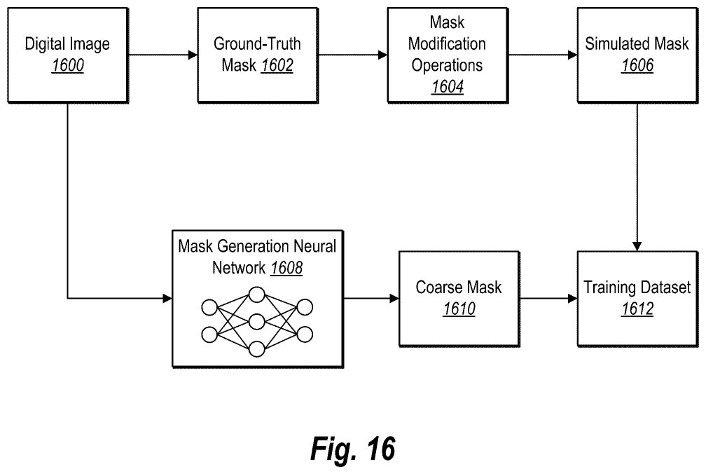

As mentioned, in one or more embodiments, the mask refinement system 116 generates a training dataset including simulated masks and coarse masks of digital images. FIG. 16 illustrates a diagram of the mask refinement system 116 generating a training dataset including various masks based on a digital image 1600. Specifically, as mentioned, the mask refinement system 116 uses ground-truth masks of digital images to generate simulated masks including synthetically modified details. For example, the mask refinement system 116 determines a ground-truth mask 1602 including a masked portion for one or more objects in the digital image 1600. To illustrate, the ground-truth mask 1602 includes an image mask generated and annotated by a user (e.g., via a digital image application.

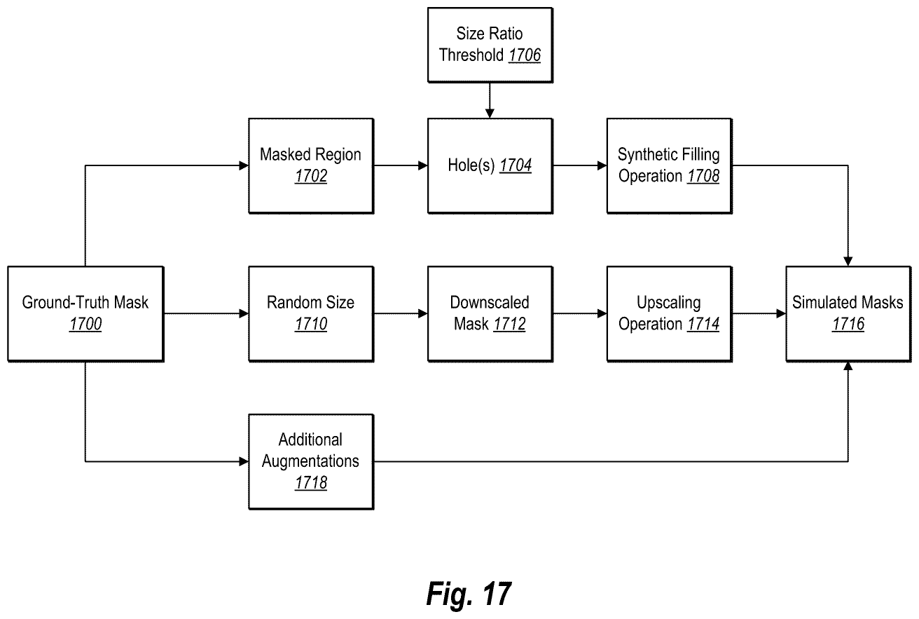

In connection with determining the ground-truth mask 1602, the mask refinement system 116 utilizes mask modification operations 1604 on the ground-truth mask 1602 to generate a simulated mask 1606. In particular, the simulated mask 1606 include a modified version of the ground-truth mask 1602 of the digital image 1600 via one or more of the mask modification operations 1604. For example, as described in more detail below with respect to FIG. 17, the mask refinement system 116 performs the mask modification operations 1604 on the ground-truth mask 1602 to introduce one or more perturbations, errors, or other data corruptions into the ground-truth mask 1602, thereby extending the flexibility of the mask refinement neural network 1500 to different possible scenarios into a training dataset 1612 not included in a set of ground-truth masks. In some examples, the mask modification operations 1604 include synthetically filling holes, mask resizing, binarization, dilation, erosion, global shifts, blurring, blending linear results, and/or other operations.

Furthermore, in one or more embodiments, the mask refinement system 116 generates coarse masks to bridge the gap between training and inference of the mask refinement neural network. For example, the mask refinement system 116 generates a coarse mask 1610 from the digital image 1600 using a mask generation neural network 1608 that outputs the coarse mask 1610 at a lower resolution than the ground-truth mask 1602 and/or with possible imperfections in the boundaries of masked regions. To illustrate, the mask generation neural network 1608 estimates the boundaries of the masked region(s) for later refinement utilizing the mask refinement neural network.

The mask refinement system 116 generates the training dataset 1612 to include the simulated mask 1606 and the coarse mask 1610. By including the simulated mask 1606 and the coarse mask 1610 in the training dataset 1612, the mask refinement system 116 allows for optimizations of the parameters of the mask refinement neural network under different conditions. For instance, the training dataset 1612 provides training under various scenarios including digital images with thin objects, complex boundaries, uncertain regions, and/or various types of digital image corruptions/errors. In one or more embodiments, the mask refinement system 116 also generates the training dataset 1612 to include trimaps for use in generating simulated masks, which provides improved recognition of uncertain regions in the mask refinement neural network.

FIG. 17 illustrates a diagram of the mask refinement system 116 generating simulated masks from ground-truth masks via various mask modification operations. In particular, as illustrated, the mask refinement system 116 determines a ground-truth mask 1700 for a digital image including annotated regions (e.g., pixels) indicating whether the regions belong to a masked region 1702, including whether the regions have corresponding alpha values. In one or more embodiments, the mask refinement system 116 performs a synthetic hole filling operation to simulate errors in hole(s) 1704 of the masked region 1702. To illustrate, the mask refinement system 116 detects the hole(s) 1704 in the masked region 1702, such as by determining interior boundaries located inside an outer boundary of the masked region 1702. In some instances, the mask refinement system 116 utilizes one or more edge detection algorithms to detect the hole(s) 1704 in the masked region 1702.

Additionally, in one or more embodiments, the determines whether the hole(s) 1704 meet a specific threshold. For example, the mask refinement system 116 determines whether the hole(s) 1704 meet a size ratio threshold 1706 based on their relative size to the masked region 1702. Specifically, the mask refinement system 116 determines a size of the masked region 1702, a size of each of the hole(s) 1704, and a size ratio between the size of the masked region 1702 and the size of the corresponding hole. The mask refinement system 116 compares the determined size ratio to the size ratio threshold 1706 to identify small holes relative to the masked region 1702 (e.g., holes with sizes that are below the size ratio threshold 1706). In response to determining that the hole(s) 1704 meet the size ratio threshold 1706, the mask refinement system 116 performs a synthetic filling operation 1708 to fill the hole(s) 1704 and include them in the masked region 1702 in a simulated mask.

In one or more embodiments, the mask refinement system 116 utilizes the ground-truth mask 1700 to generate an additional simulated mask by downscaling and upscaling the ground-truth mask 1700. In particular, as illustrated, the mask refinement system 116 determines a random size 1710 for downscaling the ground-truth mask 1700 by sampling the random size 1710 from a range of sizes. In some embodiments, the mask refinement system 116 determines the random size 1710 while constraining a size ratio (e.g., H×W) based on the ground-truth mask 1700. In response to determining the random size 1710, the mask refinement system 116 generates a downscaled mask 1712 by resizing the ground-truth mask 1700 to the random size 1710. Additionally, the mask refinement system 116 performs an upscaling operation 1714 on the downscaled mask 1712 to generate the simulated mask.

In one or more embodiments, the mask refinement system 116 performs additional mask modification operations on the ground-truth mask 1700 to generate additional simulated masks. For example, as illustrated in FIG. 17, the mask refinement system 116 performs additional augmentations 1718 including, but not limited to, binarization, dilation, erosion, global shift, blur, or blending linear results on the ground-truth mask 1700 to generate a simulated mask. In some embodiments, the mask refinement system 116 generates a single simulated mask from the ground-truth mask 1700 utilizing one of the above-indicated mask modification operations. In alternative embodiments, the mask refinement system 116 generates a plurality of simulated masks 1716 from the ground-truth mask 1700 utilizing one or more of the above-indicated mask modification operations.

In some embodiments, the mask refinement system 116 also utilizes negative sample filtering on a training dataset to strike a balance between model capacity and semantic preservations. For instance, the mask refinement system 116 adds negative data filtering to eliminate situations where the differences between alpha mattes and input masks are too great (e.g., greater than a threshold). The mask refinement system 116 filters out samples (e.g., simulated masks) where the alpha values of the samples indicate high transparency regions (e.g., pixel regions with alpha values above a threshold value and/or a number of pixels with alpha values above a density threshold.).

As previously described the mask refinement system 116 utilizes a matting loss to train a mask refinement neural network based on estimated refined masks for a training dataset. FIG. 18 illustrates a diagram of the mask refinement system 116 utilizing various point-sampling operations to determine a matting loss for a particular estimated refined mask. Specifically, as described below, the mask refinement system 116 utilizes a plurality of point-sampling operations to select pixels for determining differences between the estimated refined mask 1800 and a corresponding ground-truth mask.

As illustrated in FIG. 18, the mask refinement system 116 determines a plurality of point-sampling operations to use for determining differences between the estimated refined mask 1800 and a corresponding ground-truth mask. In one or more embodiments, the mask refinement system 116 utilizes point-sampling operations including a target aware sampling operation 1802, a target dilation sampling operation 1804, and/or an input-output difference sampling operation 1806. The mask refinement system 116 selects from the point-sampling operations to determine comparison pixels 1808 for comparing to ground-truth pixels 1810 in corresponding positions from the ground-truth mask to determine a matting loss 1812.

In one or more embodiments, the target aware sampling operation 1802 includes using a ground-truth mask to enforce a model prediction by a mask refinement neural network to follow the ground truth. In particular, the target aware sampling operation 1802 involves grouping prediction pixels according to a target matting label as background, foreground, or transparent regions. Additionally, the mask refinement system 116 uses the target aware sampling operation to select a final point pool among each sub-group by ranking according to prediction loss compared to the ground truth, sampling the top portion based on the highest loss points, and randomly sampling a remaining portion (e.g., 25%).

In one or more embodiments, the target dilation sampling operation 1804 includes improving boundary performance by focusing on regions around a boundary of a masked region. For example, the target dilation sampling operation 1804 involves dilation of transparent regions in a ground-truth mask. The target dilation sampling operation 1804 also involves densely sampling in the neighbor regions of the transparent regions.

According to one or more embodiments, the input-output difference sampling operation 1806 includes sampling points according to difference regions between the ground-truth mask and the estimated refined mask 1800. Additionally, the input-output difference sampling operation 1806 involves focusing on refining the regions where the estimated refined mask 1800 includes mistakes. The mask refinement system 116 thus aims to enforce the mask refinement neural network paying attention to the areas that it missed in the estimated refined mask 1800 (e.g., in error regions).

As mentioned, the mask refinement system 116 utilizes the plurality of point-sampling operations to sample points of the estimated refined mask 1800 and determine comparison pixels 1808 for comparing to the ground-truth pixels 1810 at the same locations. In one or more embodiments, the mask refinement system 116 randomly chooses one of the point-sampling operations (e.g., by randomly selecting the target aware sampling operation 1802, the target dilation sampling operation 1804, or the input-output difference sampling operation 1806) for use in sampling pixels of the estimated refined mask 1800. For each estimated refined mask, the mask refinement system 116 randomly selects from the point-sampling operations to determine the matting loss. Accordingly, the mask refinement system 116 improves the performance of the mask refinement neural network by using a plurality of different point-sampling operations to determine losses for various estimated refined masks.

According to one or more embodiments, the mask refinement system 116 determines the matting loss 1812 as a combination of a plurality of losses over a training dataset. For example, the mask refinement system 116 determines a regression loss L_{regress}, a Laplacian loss Lₗₐₚ, and a gradient penalty loss Lgp. The mask refinement system 116 determines the total loss Lₜₒₜₐₗ from the sum of the plurality of losses as Lₜₒₜₐₗ=L_{regress}+Lₗₐₚ+L_{gp}.

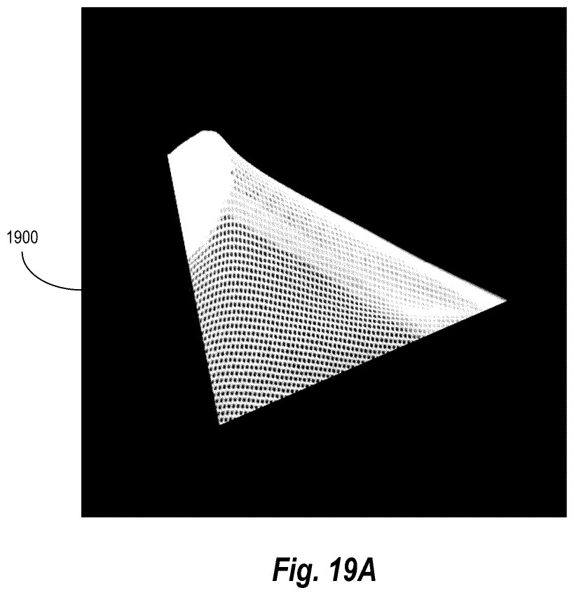

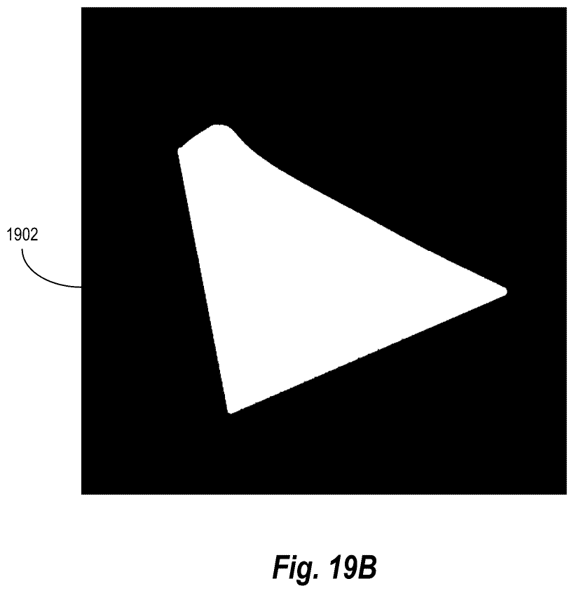

As mentioned, in one or more embodiments, the mask refinement system 116 utilizes various mask modification operations to generate simulated masks from ground-truth masks. FIGS. 19A-19B illustrate a comparison of a ground-truth mask 1900 and a simulated mask 1902 generated by applying one or more mask modification operations to the ground-truth mask 1900. In particular, the mask refinement system 116 generates the simulated mask 1902 by performing synthetic hole filling operations on the holes of the masked region in the ground-truth mask 1900 that meet a size ration threshold. Because the masked region includes a large number of small holes that meet the threshold (e.g., in a mesh object from a digital image), the simulated mask 1902 includes a solid masked region generated by synthetically filling the holes in the ground-truth mask 1900.

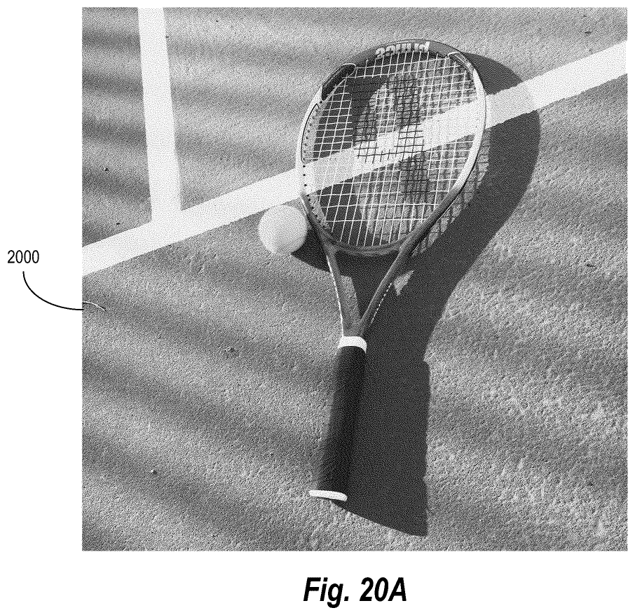

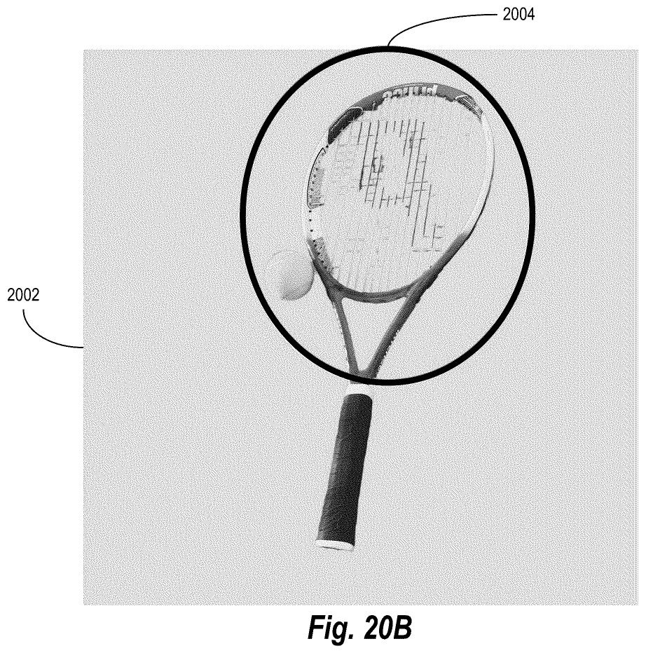

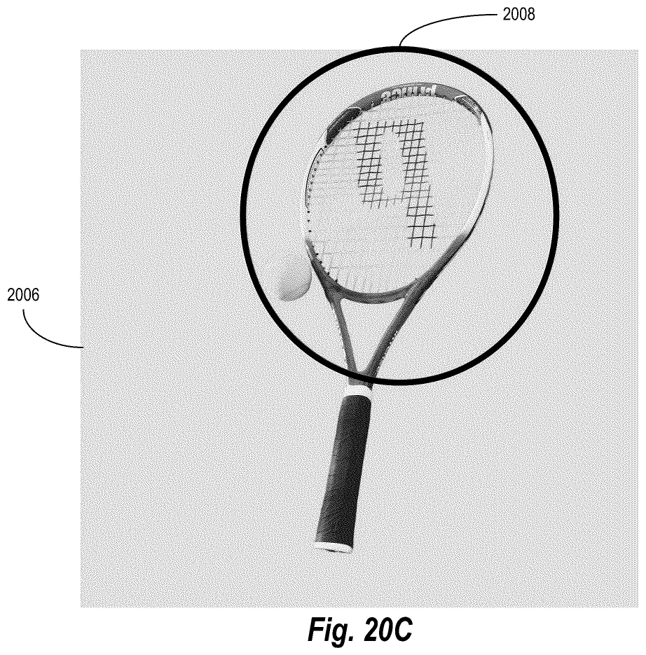

Additionally, as mentioned, the mask refinement system 116 trains a mask refinement neural network to focus on fine details of base masks by utilizing a training dataset including simulated masks with a matting loss based on randomly selected point-sampling operations. FIGS. 20A-20C illustrate a digital image and refined masks utilizing a conventional system and the mask refinement system 116. Specifically, FIG. 20A illustrates a digital image 2000 from which a mask generation system generates an initial coarse/base mask. FIG. 20B illustrates a first masked object 2002 based on an image mask generated utilizing the conventional system with a first highlighted portion 2004. FIG. 20C illustrates a second masked object 2006 based on an image mask generated utilizing the mask refinement system 116 with a trained mask refinement neural network and a second highlighted portion 2008. As illustrated, the second highlighted portion 2008 of the second masked object 2006 includes more accurate boundary detection than the first highlighted portion 2004 of the first masked object 2002, which includes many of the background details and loses information in some of the thin object regions.

As previously described, the mask generation system 102 includes a subject selection system 114 that uses selective identification of connected regions in masks to refine. FIGS. 21-28 and the corresponding description provide additional detail related to the selective refinement operations. FIG. 21 illustrates an overview diagram of the subject selection system 114 generating masks for separate connected regions of base masks for a digital image and selectively refining the region masks.

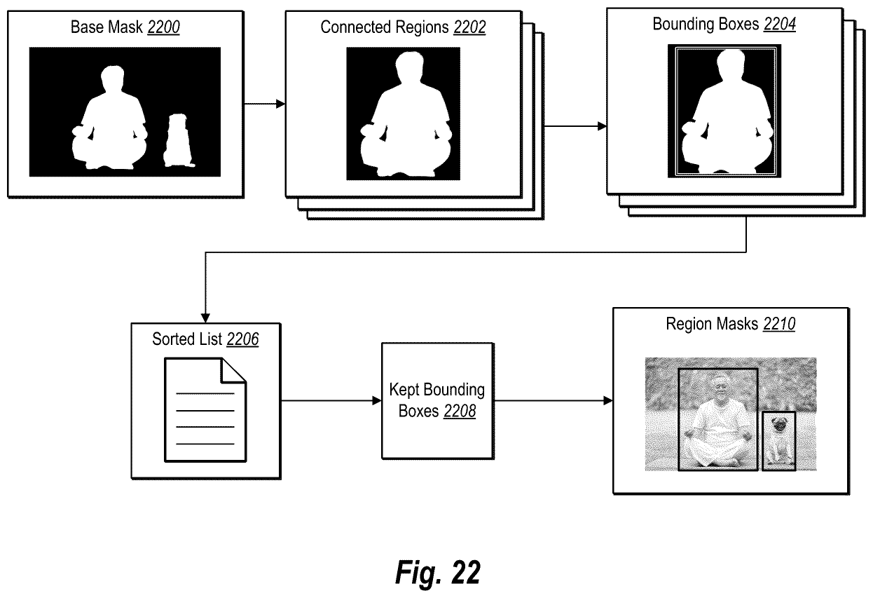

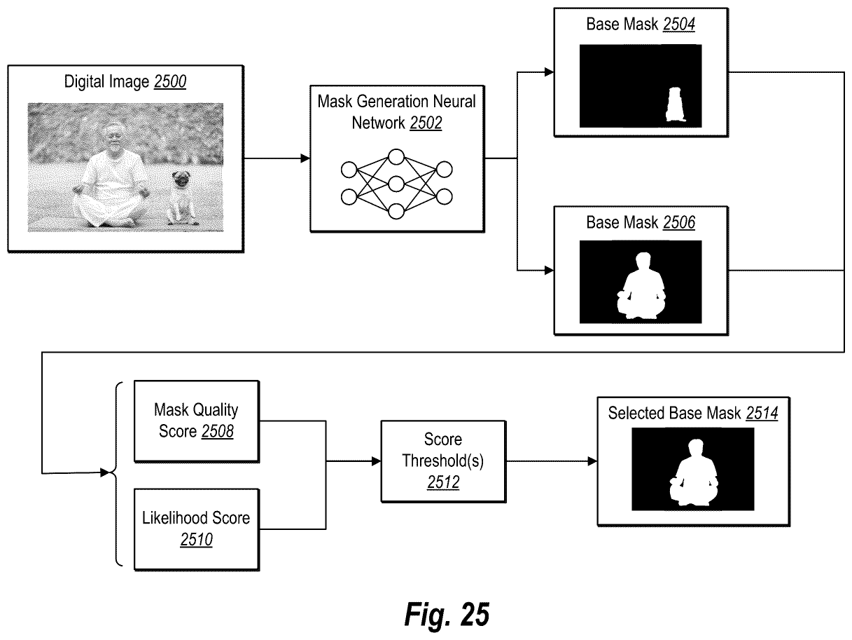

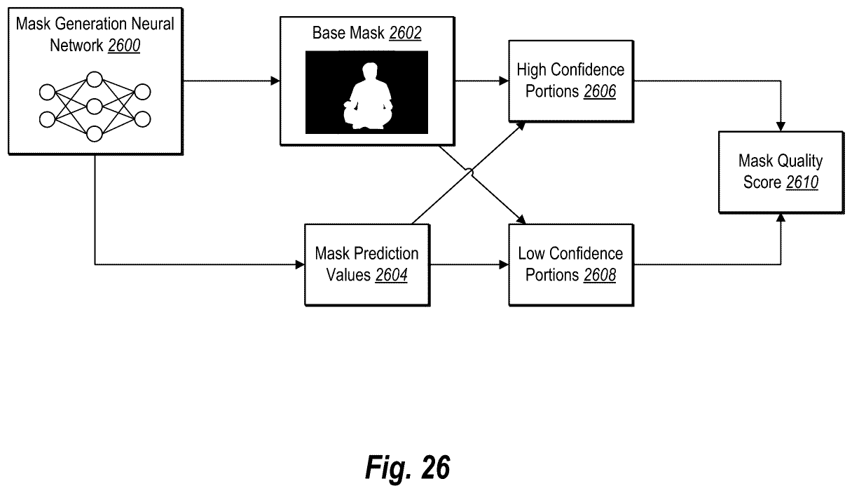

As illustrated in FIG. 21, the mask generation system 102 processes a digital image 2100 via a mask generation neural network 2102 to generate one or more base masks (e.g., base masks 2104). For example, the mask generation system 102 utilizes the multi-task segmentation system 112 to generate the base masks 2104. In response to, or otherwise in connection with, generating the base masks 2104, the mask generation system 102 utilizes the subject selection system 114 to process the base masks 2104 and determine whether and how to generate region masks 2106 for the base masks 2104. In particular, as described in more detail below with respect to FIGS. 22-24, the subject selection system 114 determines separate connected regions in a base mask and generates separate region masks via various bounding boxes. Furthermore, as described in more detail below with respect to FIGS. 25-26, the subject selection system 114 determines whether to refine portions of a base mask utilizing one or more mask scores.

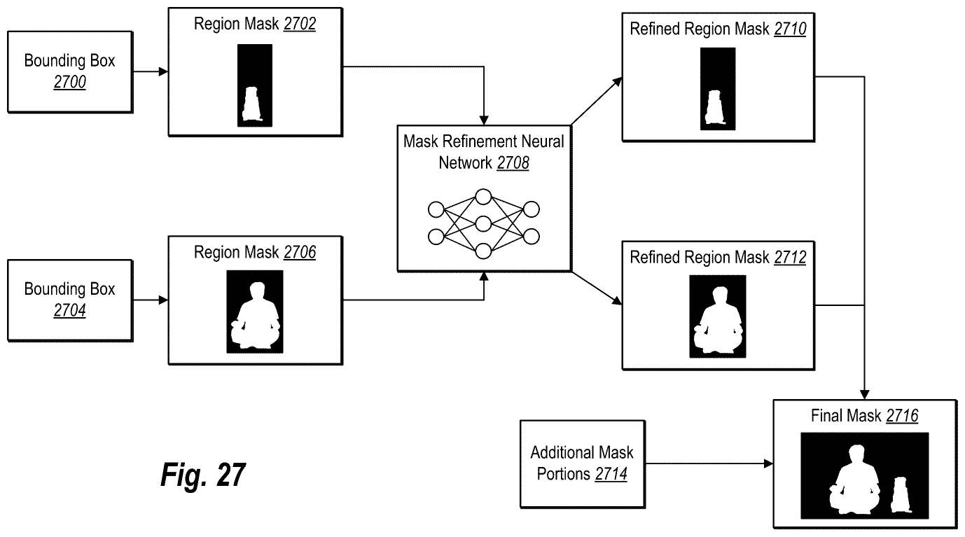

Furthermore, in response to generating the region masks 2106, the mask generation system 102 utilizes the mask refinement neural network 2108 to refine the region masks 2106 individually. Additionally, in response to refining the region masks 2106, the subject selection system 114 combines the refined region masks into a final mask 2110. FIG. 27 and the corresponding description provide additional detail related to combining region masks to generate a final mask for a digital image.

FIG. 22 illustrates an example of the subject selection system 114 identifying separate connected regions in a base mask for generating separate region masks. In particular, the subject selection system 114 determines a base mask 2200 including one or more masked regions corresponding to one or more objects in a digital image. In one or more embodiments, the base mask 2200 is one of a plurality of base masks for the digital image, as described in more detail below.

In one or more embodiments, the subject selection system 114 determines connected regions 2202 in the base mask 2200 by identifying connected pixels in the base mask 2200 belonging to a single masked region. For example, the subject selection system 114 identifies adjacent pixels that have the same value indicating that the pixels are part of the same masked region and are not separated from the masked region by any other intervening regions. To illustrate, the subject selection system 114 utilizes a connected-component labeling algorithm to scan the base mask 2200 and identify connected-pixel regions including pixels that share the same value (e.g., intensity values) based on neighboring pixels (e.g., 4-connected neighborhoods or 8-connected neighborhoods). Accordingly, the subject selection system 114 identifies the connected regions 2202, which are disconnected from each other and represent separate objects or groups of objects according to the masked regions in the base mask 2200.

In one or more embodiments, the subject selection system 114 determines bounding boxes 2204 for the connected regions. Specifically, the subject selection system 114 generates a bounding box that includes all of the pixels in a given connected region. In some embodiments, the subject selection system 114 generates tight bounding boxes such that a bounding box does not extend beyond outside pixels of the connected region horizontally or vertically. In alternative embodiments, the subject selection system 114 generates bounding boxes with buffers at the edges of the connected regions (e.g., a buffer of several pixels in each direction with the exception of bounding boxes at edges of the base mask 2200).

In response to generating bounding boxes 2204 for the connected regions 2202, the subject selection system 114 generates a sorted list 2206 of the bounding boxes 2204. In particular, the subject selection system 114 generates the sorted list 2206 for use in determining whether and how to merge one or more of the bounding boxes for determining regions of the base mask 2200 for defining separate region masks. For example, the subject selection system 114 generates the sorted list 2206 by sorting the bounding boxes 2204 according to size (e.g., pixel area), such that the largest bounding boxes are listed first and the smallest bounding boxes are listed last.

In one or more embodiments, the subject selection system 114 uses the sorted list 2206 to determine whether to merge one or more bounding boxes with one or more other bounding boxes. Specifically, the subject selection system 114 iterates through the sorted list 2206 to determine whether to merge a bounding box with any previous bounding boxes based on the size and/or coordinates. Additionally, the subject selection system 114 generates a set of kept bounding boxes 2208 including bounding boxes that were not merged into any other bounding boxes.

In response to determining the set of kept bounding boxes 2208, the subject selection system 114 generates region masks 2210. For instance, the subject selection system 114 iterates through the set of kept bounding boxes 2208 and generates a region mask for each of the bounding boxes in the set of kept bounding boxes 2208. To illustrate, the subject selection system 114 generates the region masks 2210 by cropping the base mask 2200 to the corresponding bounding boxes or otherwise copying portions of the base mask 2200 corresponding to the portions of the base mask 2200 into separate image masks.

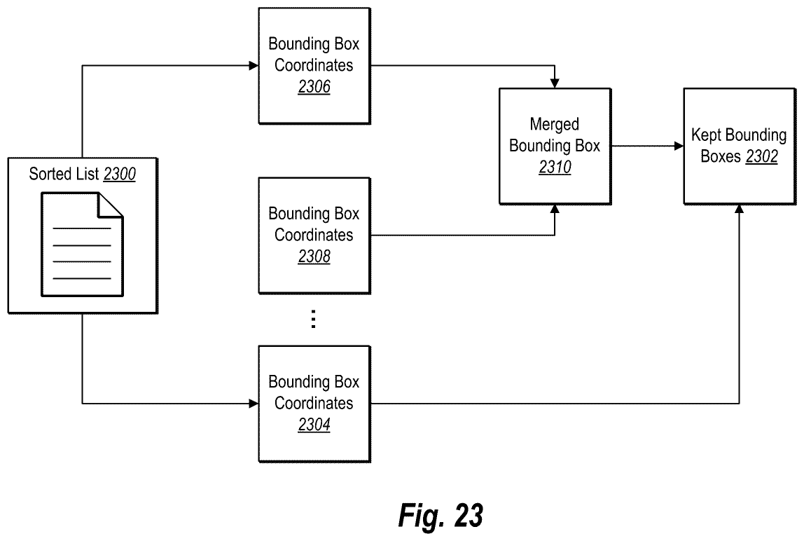

FIG. 23 illustrates an example diagram of the subject selection system 114 searching a sorted list 2300 of bounding boxes to determine whether to merge one or more bounding boxes into one or more other bounding boxes. For example, as mentioned, the sorted list 2300 includes a plurality of bounding boxes corresponding to separate connected regions in a digital image. Additionally, the bounding boxes in the sorted list 2300 are sorted according to one or more attributes of the bounding boxes, such as by size.

In one or more embodiments, the subject selection system 114 selects a first bounding box in the sorted list 2300 to determine whether to merge the bounding box into another bounding box. Specifically, the subject selection system 114 looks at a set of kept bounding boxes 2302 to determine whether there are any bounding boxes that meet one or more criteria for merging with the selected bounding box. For example, in response to selecting the first bounding box in the sorted list after initializing the merging process, the subject selection system 114 determines that the set of kept bounding boxes is empty 2302 and appends the first bounding box to the set of kept bounding boxes 2302 and removes the first bounding box from the sorted list 2300. More specifically, the subject selection system 114 appends the bounding box to the set of kept bounding boxes 2302 by adding bounding box coordinates 2304 to the set of kept bounding boxes 2302, and in some cases, a bounding box identifier.

In one or more embodiments, the subject selection system 114 utilizes the updated set of kept bounding boxes 2302 to test against other bounding boxes in the sorted list 2300. For instance, while the sorted list 2300 still contains bounding boxes, the subject selection system 114 moves to the next bounding box in the sorted list 2300 according to size. To illustrate, the subject selection system 114 compares coordinates of bounding boxes in the sorted list 2300 to the coordinates of bounding boxes in the set of kept bounding boxes 2302 to determine whether the bounding boxes overlap, or whether one bounding box is contained within another bounding box.

As illustrated in FIG. 23, the subject selection system 114 determines first bounding box coordinates 2306 corresponding to a selected bounding box from the sorted list 2300. The subject selection system 114 iterates through the set of kept bounding boxes 2302 to determine whether the selected bounding box is contained within a bounding box previously added to the set of kept bounding boxes 2302 based on the first bounding box coordinates 2306. As an example, the subject selection system 114 compares the first bounding box coordinates 2306 of the selected bounding box to second bounding box coordinates 2308 of a bounding box from the set of kept bounding boxes 2302.

In response to determining that the first bounding box coordinates 2306 are inside the second bounding box coordinates 2308, the subject selection system 114 merges the selected bounding box into the other bounding box, resulting in a merged bounding box 2310. In one or more embodiments, the subject selection system 114 only merges the selected bounding box into the other bounding box if the first bounding box coordinates 2306 are contained entirely within the second bounding box coordinates 2308. To illustrate, the subject selection system 114 determines that merges a small connected region with a separate, larger connected region in response to determining that the bounding box of the small connected region is inside the bounding box of the larger connected region. In alternative embodiments, the subject selection system 114 merges the selected bounding box into the other bounding box if a threshold percentage of the first bounding box coordinates 2306 overlaps with the second bounding box coordinates 2308. Alternatively, the subject selection system 114 adds a buffer of pixels to the second bounding box coordinates 2308 for comparison to the first bounding box coordinates 2306.

As mentioned, the subject selection system 114 iterates through the sorted list 2300 and the set of kept bounding boxes 2302 to compare each of the bounding boxes in the sorted list 2300 to one or more bounding boxes in the set of kept bounding boxes 2302. In one or more embodiments, the subject selection system 114 sorts the bounding boxes in the set of kept bounding boxes 2302 by size such that the subject selection system 114 compares the bounding boxes in the sorted list 2300 to the largest bounding box in the set of kept bounding boxes 2302 first. In one or more embodiments, if a selected bounding box does not overlap with any of the bounding boxes in the set of kept bounding boxes 2302, the subject selection system 114 appends the selected bounding box to the set of kept bounding boxes 2302. The subject selection system 114 continues merging or appending bounding boxes into the set of kept bounding boxes 2302 until the sorted list 2300 is empty.

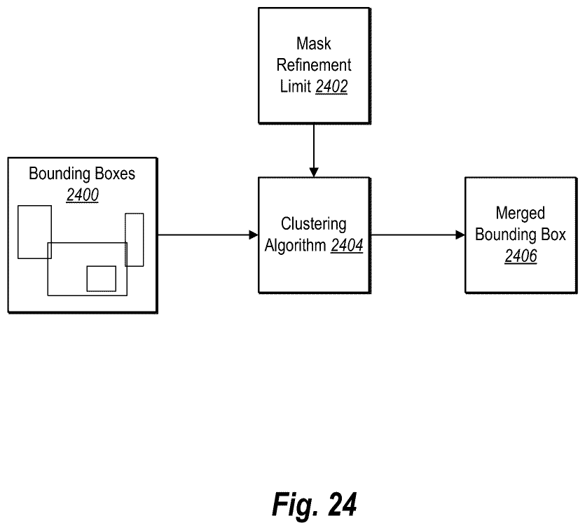

In one or more embodiments, the subject selection system 114 utilizes an additional merging algorithm for merging bounding boxes. In particular, as described above, FIG. 23 illustrates a process for merging bounding boxes contained in areas of other bounding boxes. In additional embodiments, the subject selection system 114 merges bounding boxes that are not contained within other bounding boxes or that do not overlap with other bounding boxes. For example, FIG. 24 illustrates that the subject selection system 114 merges bounding boxes 2400 based on a mask refinement limit 2402 via a clustering algorithm 2404.

According to one or more embodiments, the subject selection system 114 determines the bounding boxes 2400 from a set of kept bounding boxes (e.g., after merging one or more bounding boxes as described above). Additionally, the subject selection system 114 determines the mask refinement limit 2402 indicating a limit on the number of times the mask generation system 102 utilizes a mask refinement neural network to generate an image mask (e.g., a number of separate region masks to generate and refine). For example, the subject selection system 114 determines the mask refinement limit 2402 based on a user preference indicating a number of refinement steps desired for generating an image mask for a digital image. Alternatively, the subject selection system 114 determines the mask refinement limit 2402 based on available computing resources, a processing time limit, or other constraint.

In one or more embodiments, as illustrated in FIG. 24, the subject selection system 114 utilizes the clustering algorithm 2404 to cluster the bounding boxes 2400 and reduce the number of bounding boxes according to the mask refinement limit 2402. Specifically, the subject selection system 114 utilizes a clustering algorithm 2404 such as k-means clustering to group the bounding boxes 2400 into a number of groups determined by the mask refinement limit 2402. To illustrate, for a mask refinement limit of four, the subject selection system 114 utilizes the clustering algorithm 2404 to cluster the bounding boxes 2400 into four or fewer groups, depending on the number of bounding boxes 2400, the sizes of the bounding boxes 2400, and the locations of the bounding boxes 2400.

Additionally, in response to clustering the bounding boxes 2400 utilizing the clustering algorithm 2404 to cluster the bounding boxes 2400 into groups, the subject selection system 114 determines one or more merged bounding boxes (e.g., merged bounding box 2406). For instance, the subject selection system 114 merges each group into a separate bounding box by determining minimum and maximum vertical and horizontal coordinates (e.g., along the x and y axes) for each group and generating a bounding box with the minimum and maximum coordinates for each axis. The subject selection system 114 thus merges the set of kept bounding boxes into specific regions of the digital image that each include one or more connected regions. In one or more additional embodiments, if the number of bounding boxes 2400 is less than or equal to the mask refinement limit 2402, the subject selection system 114 uses the bounding boxes 2400 as the regions. The subject selection system 114 generates region masks based on the identified regions.

As mentioned, in one or more embodiments, the mask generation system 102 generates a plurality of image masks (e.g., base masks or coarse masks) for a digital image. FIG. 25 illustrates an example process in which the subject selection system 114 utilizes one or more mask scores to determine whether to keep base masks generated for a digital image for further processing. In particular, FIG. 25 illustrates that the subject selection system 114 generates a plurality of scores based for use in selecting one or more base masks.

As illustrated, the subject selection system 114 processes a digital image 2500 utilizing a mask generation neural network 2502 to generate a plurality of base masks (e.g., a first base mask 2504 and a second base mask 2506). In response to generating the base masks, the subject selection system 114 generates one or more scores (e.g., a mask quality score 2508 and a likelihood score 2510) for each of the base masks. In one or more embodiments, the mask quality score 2508 represents a quantitative measurement of a quality of a base mask. FIG. 26 and the corresponding description provide additional detail related to generating the mask quality score 2508. In one or more embodiments, the likelihood score 2510 represents a measurement generated by the mask generation neural network 2502 indicating how likely each base mask will be preferred by a human (e.g., learned from annotations in a training dataset).

In one or more embodiments, the subject selection system 114 compares the scores to score threshold(s) 2512. For example, the subject selection system 114 compares the mask quality score 2508 to a first score threshold and the likelihood score 2510 to a second score threshold. In response to the mask quality score 2508 and the likelihood score 2510 of a base mask (e.g., the first base mask 2504) meeting the first score threshold and the second score threshold, respectively, the subject selection system 114 determines the base mask as a selected base mask 2514. Alternatively, the subject selection system 114 combines the mask quality score 2508 and the likelihood score 2510 to generate a single mask score, such as by summing or multiplying the mask quality score 2508 and the likelihood score 2510. Accordingly, the subject selection system 114 compares the combined mask score to a single score threshold to determine whether to select the base mask.

As mentioned, FIG. 26 illustrates an example of the subject selection system 114 utilizing a scoring algorithm to generate a mask quality score for an image mask. In particular, the mask generation system 102 utilizes a mask generation neural network 2600 to generate a base mask 2602 for a digital image. In connection with generating the base mask 2602, the mask generation neural network 2600 generates mask prediction values 2604 for the pixels of the base mask 2602 indicating confidence scores that each of the pixels belongs to the indicated regions. For example, the mask generation neural network 2600 generates a prediction for a given pixel indicating whether the pixel belongs to a foreground region or a background region based on a mask prediction value generated in a specific range of values (e.g., 0 to 1). To illustrate, foreground regions have higher mask prediction values (e.g., ˜1) and background regions have lower mask prediction values (e.g., ˜0).

According to one or more embodiments, the subject selection system 114 utilizes the mask prediction values 2604 to determine high confidence portions 2606 of a masked region (e.g., in a foreground region) of the base mask 2602 and low confidence portions 2608 (e.g., uncertain portions) of the masked region. Specifically, the subject selection system 114 determines pixels of the masked region of the base mask 2602 for which the mask generation neural network 2600 has high confidence and pixels for which the mask generation neural network 2600 has low confidence. In one or more embodiments, the subject selection system 114 utilizes a plurality of thresholds to determine the high confidence portions 2606 and the low confidence portions 2608. For example, the subject selection system 114 determines the high confidence portions 2606 in response to determining pixels of the masked region that have a mask prediction value above a first threshold (e.g., 0.8). Additionally, the subject selection system 114 determines the low confidence portions 2608 in response to determining pixels that have a mask prediction value below the first threshold and above a second threshold (e.g., 0.1).

In one or more embodiments, the subject selection system 114 generates a mask quality score 2610 for the base mask 2602 by determining a ratio between the high confidence portions 2606 and the low confidence portions 2608. For example, the subject selection system 114 generates the mask quality score 2610 by dividing the high confidence portions 2606 (e.g., the number of pixels) by the low confidence portions 2608. Accordingly, the mask quality score 2610 represents a relationship between the amount of the base mask 2602 that is high confidence and the amount of the base mask 2602 that is low confidence. Thus, the greater the ratio between the high confidence portions 2606 and the low confidence portions 2608, the larger the mask quality score 2610, and vice-versa.

In one or more embodiments, as previously described, the subject selection system 114 refines individual region masks and recombines the refined region masks to generate a final mask for a digital image. FIG. 27 illustrates the subject selection system 114 generating and refining image masks for separate regions of a base mask and combining the refined masks into a final mask.

As previously described, the subject selection system 114 generates region masks for separate regions of a base mask based on separate bounding boxes. In one or more embodiments, as illustrated, the subject selection system 114 determines a first bounding box 2700 corresponding to one or more connected regions of the base mask and generates a first region mask 2702 from the first bounding box 2700. Additionally, the subject selection system 114 determines a second bounding box 2704 corresponding to one or more additional connected regions of the base mask and generates a second region mask 2706 from the second bounding box 2704. In various embodiments, the bounding boxes correspond to bounding boxes of individual connected regions or merged bounding boxes for nearby connected regions according to the merging processes described above.

In response to determining the region masks, the subject selection system 114 utilizes a mask refinement neural network 2708 to refine the region masks. In particular, the subject selection system 114 utilizes a mask refinement neural network as previously described (e.g., with respect to FIG. 14). The mask refinement neural network 2708 generates a first refined region mask 2710 from the first region mask 2702 and a second refined region mask 2712 from the second region mask 2706 in separate refinement operations. To illustrate, the subject selection system 114 utilizes the mask refinement neural network 2708 to generate the first refined region mask 2710. After generating the first refined region mask 2710, the subject selection system 114 utilizes the mask refinement neural network 2708 to generate the second refined region mask 2712. Alternatively, the subject selection system 114 uses separate instances of the mask refinement neural network 2708 to generate the refined region masks in parallel.

In one or more embodiments, the subject selection system 114 combines the refined region masks to generate a final mask 2716. For example, the subject selection system 114 combines the first refined region mask 2710 with the second refined region mask 2712 by stitching the refined region masks together to generate the final mask 2716. In additional embodiments, the subject selection system 114 combines the refined region masks with additional mask portions 2714 from the base mask to generate the final mask 2716. For instance, if one or more portions of the base mask are not included in any of the region masks, the subject selection system 114 does not refine such portions of the base mask. Accordingly, the additional mask portions 2714 include the unrefined portions of the base mask, and the subject selection system 114 stitches these portions of the base mask together with the refined portions of the base mask to generate the final mask 2716.

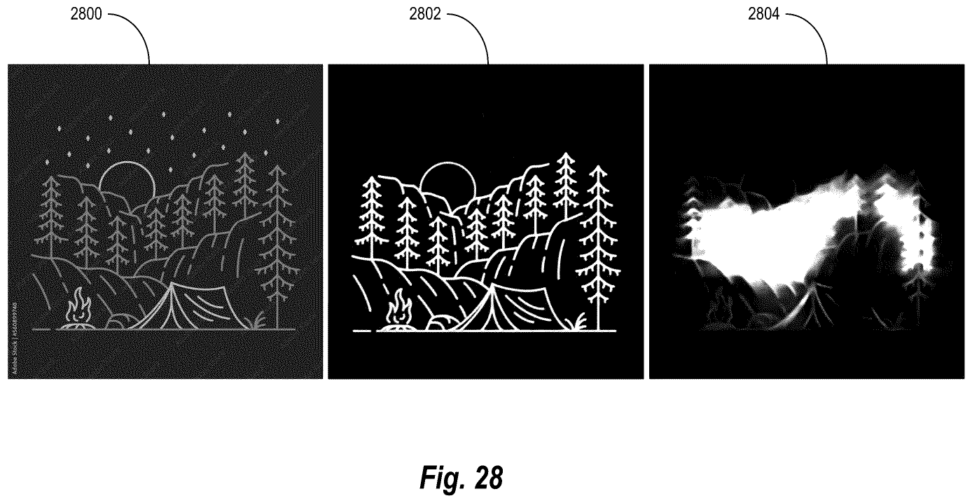

As previously described, the subject selection system 114 provides improved mask generation over conventional systems. FIG. 28 illustrates a comparison of image masks generated for a digital image 2800 utilizing the subject selection system 114 and a conventional system. FIG. 28 illustrates that the subject selection system 114 generates a first image mask 2802, and the conventional system generates a second image mask 2804. As illustrated, the subject selection system 114 is able to select base masks that are usable while also being able to refine certain regions to provide high quality details in the first image mask 2802. In contrast, the conventional system generates an image mask that is unusable and does not accurately reflect the content of the digital image 2800.

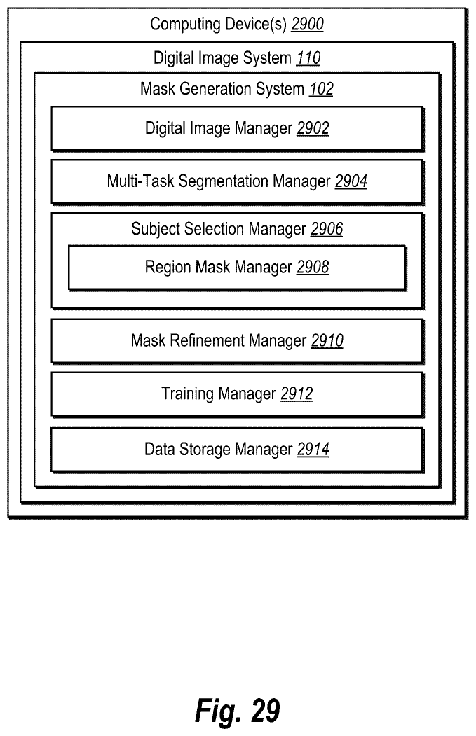

FIG. 29 illustrates a detailed schematic diagram of an embodiment of the mask generation system 102 described above. As shown, the mask generation system 102 (including the multi-task segmentation system 112, the subject selection system 114, and the mask refinement system 116) is implemented in a digital image system 110 on computing device(s) 2900 (e.g., a client device and/or server device as described in FIG. 1, and as further described below in relation to FIG. 33). Additionally, the mask generation system 102 includes, but is not limited to, a digital image manager 2902, a multi-task segmentation manager 2904, a subject selection manager 2906 including a region mask manager 2908, a mask refinement manager 2910, a training manager 2912, and a data storage manager 2914. In one or more embodiments, the mask generation system 102 is implemented on any number of computing devices. For example, the mask generation system 102, in one or more embodiments, is implemented in a distributed system of server devices for digital image processing. Alternatively, the mask generation system 102 is also implemented within one or more additional systems. For example, the mask generation system 102, in one or more embodiments, is implemented on a single computing device such as a single client device.

In one or more embodiments, each of the components of the mask generation system 102 is in communication with other components using any suitable communication technologies. Additionally, the components of the mask generation system 102 are capable of being in communication with one or more other devices including other computing devices of a user, server devices (e.g., cloud storage devices), licensing servers, or other devices/systems. It will be recognized that although the components of the mask generation system 102 are shown to be separate in FIG. 10, in other embodiments, one or more of the subcomponents are combined into fewer components, such as into a single component, or divided into more components as serves a particular implementation. Furthermore, although the components of FIG. 10 are described in connection with the mask generation system 102, at least some of the components for performing operations in conjunction with the mask generation system 102 described herein are implemented on other devices within the environment in other embodiments.

In some embodiments, the components of the mask generation system 102 include software, hardware, or both. For example, the components of the mask generation system 102 include one or more instructions stored on a computer-readable storage medium and executable by processors of one or more computing devices (e.g., the computing device(s) 2900). When executed by the one or more processors, the computer-executable instructions of the mask generation system 102 cause the computing device(s) 2900 to perform the operations described herein. Alternatively, the components of the mask generation system 102 include hardware, such as a special purpose processing device to perform a certain function or group of functions. Additionally, or alternatively, the components of the mask generation system 102 include a combination of computer-executable instructions and hardware.

Furthermore, the components of the mask generation system 102 performing the functions described herein with respect to the mask generation system 102 may, for example, be implemented as part of a stand-alone application, as a module of an application, as a plug-in for applications, as a library function or functions that may be called by other applications, and/or as a cloud-computing model. Thus, the components of the mask generation system 102 may be implemented as part of a stand-alone application on a personal computing device or a mobile device. Alternatively, or additionally, the components of the mask generation system 102 may be implemented in any application that provides digital image editing, including, but not limited to ADOBE® PHOTOSHOP® and ADOBE® CREATIVE CLOUD® software.

As illustrated, the mask generation system 102 includes a digital image manager 2902 to manage digital images for various image processing operations. In particular, the digital image manager 2902 accesses digital images for editing and masking operations, such as by accessing the digital images from an image database. Additionally, the digital image manager 2902 accesses digital images for generating training datasets.

Additionally, the mask generation system 102 includes a multi-task segmentation manager 2904 to perform a plurality of image segmentation tasks utilizing a single segmentation neural network. For example, the multi-task segmentation manager 2904 utilizes a multi-task segmentation neural network to generate a plurality of image masks for a digital image. For example, the multi-task segmentation manager 2904 includes the multi-task segmentation system 112, which utilizes the multi-task segmentation neural network to generate various image segmentations for one or more objects or groups of objects in a digital image.

The mask generation system 102 also includes a subject selection manager 2906 to provide selective refinement of portions of image masks. For example, the subject selection manager 2906 includes the subject selection system 114 for selectively identifying portions of a base mask corresponding to connected regions. Additionally, the subject selection manager 2906 detects and merges bounding boxes corresponding to connected regions. The subject selection manager 2906 includes a region mask manager 2908 to generate region masks for different connected regions based on bounding box coordinates. The subject selection manager 2906 also communicates with the mask refinement manager 2910 to refine the region masks.

In one or more embodiments, the mask generation system 102 includes a mask refinement manager 2910 to refine image masks and portions of image masks. In particular, the mask refinement manager 2910 uses base masks generated by the multi-task segmentation manager 2904 and/or region masks generated by the subject selection manager 2906 to generate refined image masks. The mask refinement manager 2910 includes the mask refinement system 116 to refine the base masks and/or region masks via a mask refinement neural network. Additionally, the mask refinement manager 2910 communicates with the training manager 2912 to train a mask refinement neural network.

As mentioned, the mask generation system 102 includes a training manager 2912 to train one or more neural networks involved in mask generation or refinement. For example, the training manager 2912 generates or obtains training datasets for training a mask generation neural network (e.g., a multi-task segmentation neural network) and/or a mask refinement neural network. Additionally, the training manager 2912 trains a multi-task segmentation neural network and/or a mask refinement neural network by modifying parameters of the neural network(s). Furthermore, in some embodiments, the training manager 2912 jointly or separately trains the multi-task segmentation neural network and the mask refinement neural network.

The mask generation system 102 also includes a data storage manager 2914 (that comprises a non-transitory computer memory) that stores and maintains data associated with generating and refining image masks for digital images. For example, the data storage manager 2914 stores digital images, base masks, region masks, refined masks, and final masks. Additionally, the data storage manager 2914 stores data associated with training and utilizing neural networks, including image training datasets, image features, and mask features.

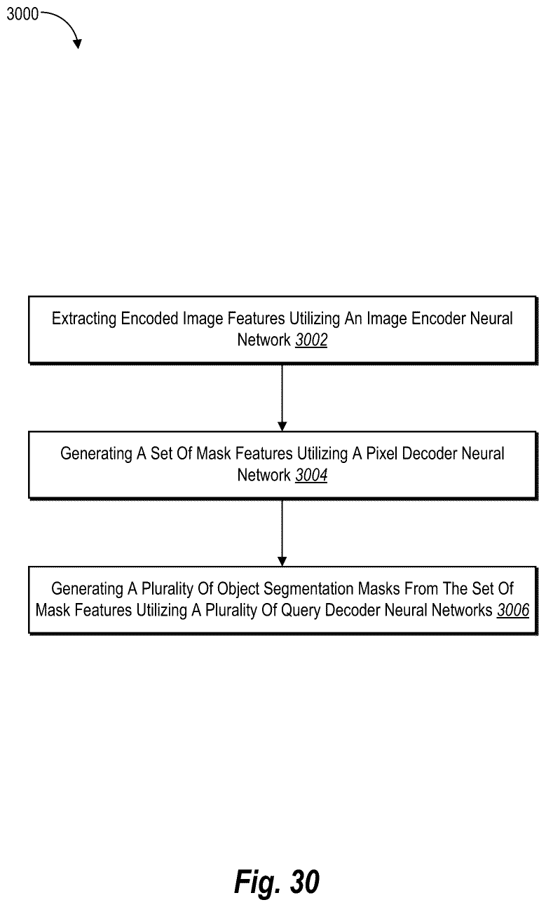

Turning now to FIG. 30, this figure shows a flowchart of a series of acts 3000 of using a single model with a plurality of query decoder neural networks to perform a plurality of separate segmentation tasks on a digital image. While FIG. 30 illustrates acts according to one embodiment, alternative embodiments may omit, add to, reorder, and/or modify any of the acts shown in FIG. 30. The acts of FIG. 30 are part of a method. Alternatively, a non-transitory computer readable medium comprises instructions, that when executed by one or more processors, cause the one or more processors to perform the acts of FIG. 30. In still further embodiments, a system includes a processor or server configured to perform the acts of FIG. 30.

As shown, the series of acts 3000 includes an act 3002 of extracting encoded image features utilizing an image encoder neural network. The series of acts 3000 also includes an act 3004 of generating a set of mask features utilizing a pixel decoder neural network. The series of acts 3000 further includes an act 3006 of generating a plurality of object segmentation masks from the set of mask features utilizing a plurality of query decoder neural networks.

In one or more embodiments, act 3002 involves extracting, utilizing an image encoder neural network, encoded feature maps from a digital image. Act 3004 involves generating, utilizing a pixel decoder neural network, a set of mask features from the encoded feature maps generated by the image encoder neural network. Act 3006 involves generating, utilizing a plurality of query decoder neural networks in connection with a plurality of segmentation tasks for the digital image, a plurality of object segmentation masks from the set of mask features generated by the pixel decoder neural network according to a plurality of separate sets of learned queries.

In one or more embodiments, the series of acts 3000 includes generating the set of mask features from the encoded feature maps comprises generating the set of mask features as a single set of mask features based on the encoded feature maps utilizing a transformer neural network of the pixel decoder neural network. The series of acts 3000 also includes generating the plurality of object segmentation masks comprises generating the plurality of object segmentation masks from the single set of mask features utilizing the plurality of query decoder neural networks.

In one or more embodiments, the series of acts 3000 includes generating, utilizing a first query decoder neural network for a first segmentation task, a first object segmentation mask from the set of mask features generated by the pixel decoder neural network. The series of acts 3000 further includes generating, utilizing a second query decoder neural network for a second segmentation task, a second object segmentation mask from the set of mask features generated by the pixel decoder neural network.

In one or more embodiments, the series of acts 3000 includes generating, from the set of mask features, a plurality of sets of modified mask features utilizing a plurality of task adapter neural networks comprising parameters optimized according to corresponding segmentation tasks of the plurality of segmentation tasks. Furthermore, the series of acts 3000 includes generating the plurality of object segmentation masks from the plurality of sets of modified mask features. For example, the series of acts 3000 includes generating a set of modified mask features comprises refining, utilizing a task adapter neural network corresponding to a segmentation task of the plurality of segmentation tasks, the set of mask features using intermediate features generated via a plurality of layers of the pixel decoder neural network.

According to one or more embodiments, the series of acts 3000 includes generating the plurality of sets of modified mask features by upsampling the set of mask features according to dynamically generated sampling points utilizing a data-dependent upsampling layer after the pixel decoder neural network. Additionally, in one or more embodiments, the series of acts includes determining a training dataset comprising digital images for a segmentation task of the plurality of segmentation tasks in connection with a task adapter neural network and a query decoder neural network corresponding to the segmentation task. Furthermore, the series of acts 3000 includes jointly optimizing, utilizing the training dataset for the segmentation task, parameters of the data-dependent upsampling layer, the task adapter neural network, and the query decoder neural network to reduce differences between predicted object segmentation masks for the digital images and ground-truth object segmentation masks.

In one or more embodiments, the series of acts 3000 includes determining, in response to a request to edit the digital image, a set of segmentation tasks comprising the plurality of segmentation tasks corresponding to one or more image editing operations. The series of acts 3000 also includes selecting the plurality of query decoder neural networks in response to determining the set of segmentation tasks. The series of acts 3000 further includes performing the one or more image editing operations utilizing the plurality of object segmentation masks.

The series of acts 3000 further includes determining, in response to the request to edit the digital image, an object localization task corresponding to the one or more image editing operations. Additionally, the series of acts 3000 includes selecting an additional query decoder neural network in response to determining the object localization task. The series of acts 3000 also includes generating, utilizing the additional query decoder neural network, one or more object bounding boxes from the set of mask features generated by the pixel decoder neural network. The series of acts 3000 further includes performing the one or more image editing operations utilizing the one or more object bounding boxes.

In one or more embodiments, the series of acts 3000 includes determining a plurality of segmentation tasks in connection with a request to perform one or more image editing operations on the digital image. The series of acts 3000 also includes extracting, utilizing an image encoder neural network, encoded feature maps from the digital image. The series of acts 3000 also includes generating, utilizing a pixel decoder neural network, a set of mask features from the encoded feature maps generated by the image encoder neural network. The series of acts 3000 further includes generating, utilizing a plurality of query decoder neural networks corresponding to the plurality of segmentation tasks, a plurality of object segmentation masks from the set of mask features generated by the pixel decoder neural network according to a plurality of separate sets of learned queries.

In one or more embodiments, the series of acts 3000 includes providing, in response to the request, the digital image to a multi-task segmentation model comprising the image encoder neural network, the pixel decoder neural network, and a set of query decoder neural networks. The series of acts 3000 also includes selecting, from the set of query decoder neural networks of the multi-task segmentation model, the plurality of query decoder neural networks based on the plurality of segmentation tasks.

In one or more embodiments, the series of acts 3000 includes determining a first segmentation task to segment a foreground and a background in the digital image. The series of acts 3000 also includes determining a second segmentation task to perform an instance-aware segmentation on the digital image. Additionally, the series of acts 3000 includes selecting the plurality of query decoder neural networks by selecting a first query decoder neural network corresponding to the first segmentation task and a second query decoder neural network corresponding to the second segmentation task.

In one or more embodiments, the series of acts 3000 includes generating, utilizing a first query decoder neural network, a first object segmentation mask from the set of mask features generated by the pixel decoder neural network according to a first set of learned parameters. The series of acts 3000 also includes generating, utilizing a second query decoder neural network, a second object segmentation mask from the set of mask features generated by the pixel decoder neural network according to a second set of learned parameters.

In one or more embodiments, the series of acts 3000 includes generating a plurality of modified sets of mask features by refining the set of mask features utilizing a plurality of task adapter neural networks corresponding to the plurality of segmentation tasks. The series of acts 3000 includes generating, utilizing the plurality of query decoder neural networks, the plurality of object segmentation masks from the plurality of modified sets of mask features. Additionally, in one or more embodiments, the series of acts 3000 includes generating upsampled mask features by upsampling the set of mask features according to dynamically generated sampling points utilizing a data-dependent upsampler layer between the pixel decoder neural network and the plurality of query decoder neural networks. The series of acts 3000 further includes generating a modified set of mask features by successively refining, utilizing a task adapter neural network comprising a plurality of multi-scale deformable attention layers, the upsampled mask features based on intermediate features generated via a plurality of layers of the pixel decoder neural network.

In one or more embodiments, the series of acts 3000 includes determining, for a segmentation task of the plurality of segmentation tasks, a training dataset comprising digital images. The series of acts 3000 further includes jointly optimizing, utilizing the training dataset for the segmentation task, parameters of the pixel decoder neural network, a task adapter neural network corresponding to the segmentation task, and a query decoder neural network corresponding to the segmentation task to reduce differences between predicted object segmentation masks for the digital images and ground-truth object segmentation masks.

In one or more embodiments, the series of acts 3000 includes extracting, utilizing an image encoder neural network, encoded feature maps from a digital image. The series of acts 3000 also includes generating, utilizing a plurality of pixel decoder neural networks, a plurality of sets of mask features from the encoded feature maps generated by the image encoder neural network. The series of acts 3000 also includes generating, utilizing a plurality of query decoder neural networks in connection with a plurality of segmentation tasks for the digital image, a plurality of object segmentation masks from the plurality of sets of mask features generated by the plurality of pixel decoder neural networks according to a plurality of separate sets of learned queries.

In one or more embodiments, the series of acts 3000 includes generating a first set of mask features from the encoded feature maps utilizing a first pixel decoder neural network. The series of acts 3000 also includes generating a second set of mask features from the encoded feature maps utilizing a second pixel decoder neural network. The series of acts 3000 further includes generating a first set of one or more object segmentation masks from the first set of mask features utilizing a first query decoder neural network corresponding to a first segmentation task. The series of acts 3000 also includes generating a second set of one or more object segmentation masks from the second set of mask features utilizing a second query decoder neural network corresponding to a second segmentation task.

The series of acts 3000 also includes generating the plurality of sets of mask features comprises generating a plurality of sets of modified encoded feature maps for the plurality of segmentation tasks by refining, utilizing a plurality of task adapter neural networks corresponding to the plurality of segmentation tasks, the encoded feature maps generated by the image encoder neural network. The series of acts 3000 further includes generating the plurality of sets of mask features comprises generating, utilizing the plurality of pixel decoder neural networks, the plurality of sets of mask features from the plurality of sets of modified encoded feature maps generated by the plurality of task adapter neural networks. The series of acts 3000 includes determining a training dataset comprising digital images for a segmentation task of the plurality of segmentation tasks in connection with a task adapter neural network, a pixel decoder neural network, and a query decoder neural network corresponding to the segmentation task. The series of acts 3000 also includes jointly optimizing, utilizing the training dataset for the segmentation task, parameters of the task adapter neural network, the pixel decoder neural network, and the query decoder neural network to reduce differences between predicted object segmentation masks for the digital images and ground-truth object segmentation masks.

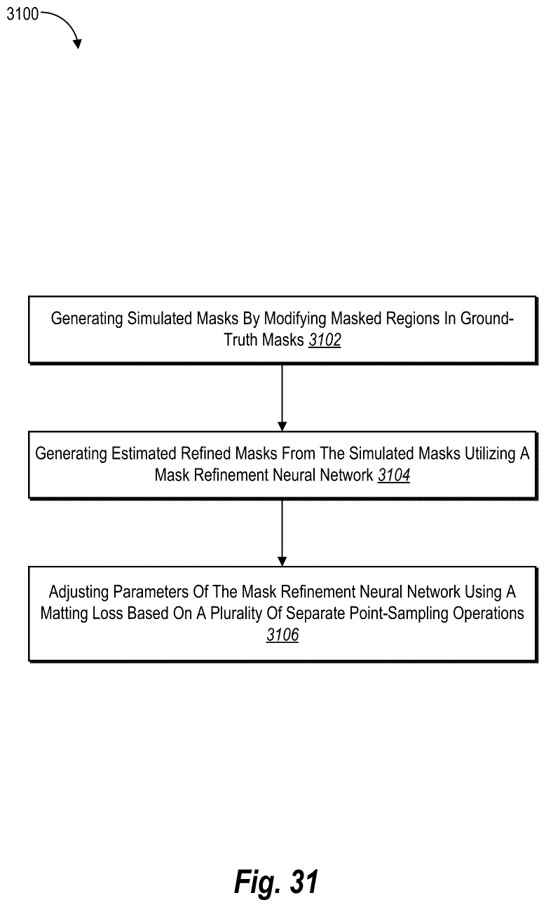

Turning now to FIG. 31, this figure shows a flowchart of a series of acts 3100 of training a refinement neural network using simulated masks with a matting loss determined via point-sampling operations. While FIG. 31 illustrates acts according to one embodiment, alternative embodiments may omit, add to, reorder, and/or modify any of the acts shown in FIG. 31. The acts of FIG. 31 are part of a method. Alternatively, a non-transitory computer readable medium comprises instructions, that when executed by one or more processors, cause the one or more processors to perform the acts of FIG. 31. In still further embodiments, a system includes a processor or server configured to perform the acts of FIG. 31.

As shown, the series of acts 3100 includes an act 3102 of generating simulated masks by modifying masked regions in ground-truth masks. The series of acts 3100 also includes an act 3104 of generating estimated refined masks from the simulated masks utilizing a mask refinement neural network. The series of acts 3100 further includes an act 3106 of adjusting parameters of the mask refinement neural network using a matting loss based on a plurality of separated point-sampling operations.

In one or more embodiments, the act 3102 involves generating simulated masks for objects in a plurality of digital images by modifying masked regions in a plurality of ground-truth masks for the objects utilizing one or more mask modification operations. Additionally, act 3104 involves generating, utilizing a mask refinement neural network, a plurality of estimated refined masks for the objects in the plurality of digital images based on the plurality of digital images and the simulated masks. Act 3106 involves adjusting parameters of the mask refinement neural network by utilizing a matting loss based on a plurality of separate point-sampling operations to reduce differences between the plurality of estimated refined masks and the plurality of ground-truth masks.

In one or more embodiments, the series of acts 3100 includes detecting one or more holes in a masked region of a ground-truth mask of the plurality of ground-truth masks. The series of acts 3100 also includes generating a simulated mask by synthetically filling the one or more holes in the masked region. In one or more embodiments, the series of acts 3100 includes determining a size ratio indicating a size of a hole in the masked region relative to a size of the masked region. The series of acts 3100 also includes selecting the hole for synthetically filling in response to determining that the size ratio is lower than a size ratio threshold.

The series of acts 3100 further includes generating downscaled masks by downscaling a subset of ground-truth masks from one or more initial sizes to a plurality of randomly selected sizes. The series of acts 3100 also includes generating a subset of simulated masks by upscaling the downscaled masks from the plurality of randomly selected sizes to the one or more initial sizes.

In one or more embodiments, the series of acts 3100 includes generating, utilizing a coarse mask generation neural network, coarse masks for objects in a plurality of additional digital images. The series of acts 3100 also includes determining a training dataset comprising the simulated masks and the coarse masks. The series of acts 3100 further includes generating the plurality of estimated refined masks based on the training dataset comprising the simulated masks and the coarse masks.

In one or more embodiments, the series of acts 3100 includes sampling a first comparison pixel in a first estimated refined mask utilizing a first point-sampling operation of the plurality of separate point-sampling operations. The series of acts 3100 also includes sampling a second comparison pixel in a second estimated refined mask utilizing a second point-sampling operation of the plurality of separate point-sampling operations. Additionally, in one or more embodiments, the series of acts 3100 includes determining the matting loss by selecting the first point-sampling operation for sampling the first comparison pixel by randomly selecting a point-sampling operation from the plurality of separate point-sampling operations. In additional embodiments, the series of acts 3100 includes determining the matting loss by selecting the first point-sampling operation and the second point-sampling operation from the plurality of separate point-sampling operations comprising a target aware sampling operation, a target dilation sampling operation, and an input-output difference sampling operation.

In one or more embodiments, the series of acts 3100 includes determining, for a digital image, that a masked region of a simulated mask is within a threshold distance of a boundary of the simulated mask. The series of acts 3100 further includes generating a padded mask by inserting a boundary padding at the boundary of the simulated mask in response to determining that the masked region is within the threshold distance. The series of acts 3100 also includes adjusting the parameters of the mask refinement neural network based on the padded mask.

In one or more embodiments, the series of acts 3100 includes generating simulated masks for objects in a plurality of digital images by modifying masked regions in a plurality of ground-truth masks for the objects utilizing one or more mask modification operations. The series of acts 3100 also includes generating, utilizing a coarse mask generation neural network, coarse masks for objects in the plurality of digital images. Additionally, the series of acts 3100 includes generating, utilizing a mask refinement neural network, a plurality of estimated refined masks for the objects in the plurality of digital images based on the plurality of digital images and a set of masks comprising the simulated masks and the coarse masks. The series of acts 3100 further includes adjusting parameters of the mask refinement neural network by utilizing a matting loss based on randomly selected point-sampling operations to reduce differences between the plurality of estimated refined masks and the plurality of ground-truth masks.

In one or more embodiments, the series of acts 3100 includes generating a first set of simulated masks by synthetically filling one or more holes in masked portions of a first subset of the plurality of ground-truth masks. The series of acts 3100 also includes generating a second set of simulated masks by: generating downscaled masks by downscaling a second subset of the plurality of ground-truth masks from one or more initial sizes to a plurality of randomly selected sizes; and upscaling the downscaled masks from the plurality of randomly selected sizes to the one or more initial sizes.

In one or more embodiments, the series of acts 3100 includes generating, utilizing a detail capture neural network of the mask refinement neural network, a first set of features at a set of resolutions from a digital image of the plurality of digital images and a corresponding simulated mask or a corresponding coarse mask. The series of acts 3100 also includes generating, utilizing a vision transformer neural network of the mask refinement neural network, a second set of features at an additional resolution from the digital image. The series of acts 3100 further includes generating an estimated refined mask by combining the first set of features and the second set of features at fusion layers of the mask refinement neural network.

In one or more embodiments, the series of acts 3100 includes sampling comparison pixels in the plurality of estimated refined masks utilizing the randomly selected point-sampling operations. The series of acts 3100 also includes determining the matting loss based on differences between the comparison pixels in the plurality of estimated refined masks and corresponding pixels in the plurality of ground-truth masks.

In one or more embodiments, the series of acts 3100 includes sampling a first comparison pixel in a first estimated refined mask of the plurality of estimated refined masks utilizing a first randomly selected point-sampling operation from a target aware sampling operation, a target dilation sampling operation, or an input-output difference sampling operation. Additionally, the series of acts 3100 includes sampling a second comparison pixel in a second estimated refined mask of the plurality of estimated refined masks utilizing a second randomly selected point-sampling operation from the target aware sampling operation, the target dilation sampling operation, or the input-output difference sampling operation. The series of acts 3100 further includes adjusting the parameters of the mask refinement neural network by determining the matting loss by combining a regression loss, a Laplacian loss, and a gradient penalty loss for the comparison pixels in the plurality of estimated refined masks and the plurality of ground-truth masks.

In one or more embodiments, the series of acts 3100 includes generating simulated masks for objects in a plurality of digital images by modifying masked regions in a plurality of ground-truth masks for the objects utilizing one or more mask modification operations. The series of acts 3100 also includes generating, utilizing a mask refinement neural network, a plurality of estimated refined masks for the objects in the plurality of digital images based on the plurality of digital images and the simulated masks. The series of acts 3100 further includes determining a matting loss indicating differences between the plurality of estimated refined masks and the plurality of ground-truth masks based on comparison pixels sampled via a plurality of separate point-sampling operations. The series of acts 3100 also includes adjusting parameters of the mask refinement neural network by utilizing the matting loss to reduce the differences between the plurality of estimated refined masks and the plurality of ground-truth masks.

In one or more embodiments, the series of acts 3100 includes detecting, in masked portions of the plurality of ground-truth masks, holes that meet a size ratio threshold. The series of acts 3100 includes generating simulated masks by synthetically filling the holes in the masked portions.

In one or more embodiments, the series of acts 3100 further includes generating, utilizing a coarse mask generation neural network, coarse masks for a plurality of additional digital images. The series of acts 3100 also includes generating a training dataset comprising the coarse masks and the simulated masks. Additionally, in one or more embodiments, the series of acts 3100 includes determining the matting loss by determining the matting loss based on the training dataset comprising the coarse masks and the simulated masks.

In one or more embodiments, the series of acts 3100 includes sampling comparison pixels from the plurality of estimated refined masks utilizing the plurality of separate point-sampling operations. The series of acts 3100 also includes determining, for the comparison pixels, corresponding pixels of the plurality of ground-truth masks. The series of acts 3100 further includes determining the matting loss by determining differences between the comparison pixels and the corresponding pixels.

In one or more embodiments, the series of acts 3100 includes sampling comparison pixels in a first estimated refined mask by randomly selecting a first point-sampling operation from the plurality of separate point-sampling operations. The series of acts 3100 also includes sampling comparison pixels in a second estimated refined mask by randomly selecting a second point-sampling operation from the plurality of separate point-sampling operations.

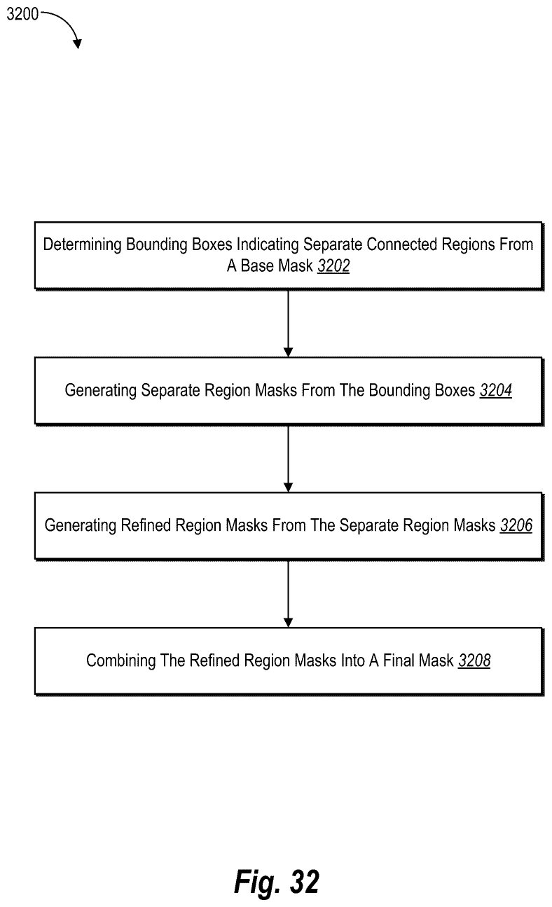

Turning now to FIG. 32, this figure shows a flowchart of a series of acts 3200 of selectively refining portions of a base mask using bounding boxes for connected regions of the base mask. While FIG. 32 illustrates acts according to one embodiment, alternative embodiments may omit, add to, reorder, and/or modify any of the acts shown in FIG. 32. The acts of FIG. 32 are part of a method. Alternatively, a non-transitory computer readable medium comprises instructions, that when executed by one or more processors, cause the one or more processors to perform the acts of FIG. 32. In still further embodiments, a system includes a processor or server configured to perform the acts of FIG. 32.

As shown, the series of acts 3100 includes an act 3202 of determining bounding boxes indicating separate connected regions from a base mask. The series of acts 3100 also includes an act 3204 of generating separate region masks from the bounding boxes. The series of acts 3100 further includes an act 3206 of generating refined region masks from the separate region masks. Additionally, the series of acts 3100 includes an act 3208 of combining the refined region masks into a final mask.

In one or more embodiments, act 3202 involves determining, by at least one processor, a plurality of bounding boxes indicating a plurality of separate connected masked regions corresponding to one or more objects in a base mask of a digital image. Act 3204 involves generating a plurality of separate region masks from the plurality of bounding boxes. Act 3206 involves generating, utilizing a mask refinement neural network, a plurality of refined region masks from the plurality of separate region masks. Additionally, act 3208 involves combining the plurality of refined region masks into a final mask for the digital image.

In one or more embodiments, the series of acts 3200 includes determining, for the digital image, a plurality of base masks generated by a mask generation neural network, the plurality of base masks comprising the base mask. The series of acts 3200 also includes selecting the base mask from the plurality of base masks in response to determining that a mask quality score of the base mask meets a score threshold. In one or more embodiments, the series of acts 3200 includes determining, based on mask prediction values generated by the mask generation neural network, high confidence portions and low confidence portions of the base mask. The series of acts 3200 also includes generating the mask quality score as a ratio of the high confidence portions to the low confidence portions.

The series of acts 3200 includes determining a first bounding box corresponding to a first set of connected pixels of a first masked region in the base mask. The series of acts 3200 also includes determining a second bounding box corresponding to a second set of connected pixels of a second masked region in the base mask. The series of acts 3200 further includes merging the first bounding box and the second bounding box into a merged bounding box of the plurality of bounding boxes in response to determining that a first area of the first bounding box and a second area of the second bounding box overlap. The series of acts 3200 also includes generating a region mask from the merged bounding box including the second area of the first bounding box and the second area of the second bounding box.

In one or more embodiments, the series of acts 3200 includes generating, from the base mask, a first region mask based on coordinates of the first bounding box. The series of acts 3200 also includes generating, from the base mask, a second region mask based on coordinates of the second bounding box. Additionally, in one or more embodiments, the series of acts 3200 includes generating the plurality of refined region masks comprises generating, utilizing the mask refinement neural network, a first refined region mask from the first region mask and a second refined region mask from a second region mask corresponding to the second bounding box. In some embodiments, the series of acts 3200 includes combining the plurality of refined region masks by combining the first refined region mask, the second refined region mask, and a portion of the base mask outside boundaries of the first refined region mask and the second refined region mask to generate the final mask for the digital image.

In one or more embodiments, the series of acts 3200 includes determining a mask refinement limit indicating a maximum number of region masks to refine via the mask refinement neural network. The series of acts 3200 also includes determining that a number of bounding boxes of the plurality of bounding boxes exceeds the mask refinement limit. Additionally, the series of acts 3200 includes merging one or more subsets of the plurality of bounding boxes utilizing a clustering algorithm in response to the number of bounding boxes exceeding the mask refinement limit.

In one or more embodiments, the series of acts 3200 includes providing, via a graphical user interface displaying the digital image, a mask refinement option to set the mask refinement limit. The series of acts 3200 further includes determining the mask refinement limit in response to a value indicated via the mask refinement option.

In one or more embodiments, the series of acts 3200 includes determining a first bounding box indicating a first connected masked region in a base mask generated for the digital image utilizing a mask generation neural network. The series of acts 3200 also includes determining a second bounding box indicating a second connected masked region in the base mask, the first connected masked region and the second connected masked region being separated in the base mask. The series of acts 3200 further includes generating a first region mask from the first bounding box and a second region mask from the second bounding box. The series of acts 3200 also includes generating, utilizing a mask refinement neural network, a first refined region mask from the first region mask and a second refined region mask from the second region mask. The series of acts 3200 also includes combining the first refined region mask and the second refined region mask into a final mask for the digital image.

In one or more embodiments, the series of acts 3200 includes determining a plurality of bounding boxes comprising the first bounding box and the second bounding box by determining sets of connected pixels in the base mask, each set of connected pixels being separated from other sets of connected pixels according to mask values.

In one or more embodiments, the series of acts 3200 includes generating a sorted list of the plurality of bounding boxes by sorting the plurality of bounding boxes according to sizes of the plurality of bounding boxes. The series of acts 3200 includes determining a merged bounding box by merging, according to the sorted list, a subset of bounding boxes in response to determining that the subset of bounding boxes overlap.

In one or more embodiments, the series of acts 3200 further includes determining a plurality of base masks generated by the mask generation neural network, the plurality of base masks comprising the base mask. The series of acts 3200 also includes generating mask quality scores for the plurality of base masks based on mask prediction values generated by the mask generation neural network for the plurality of base masks. The series of acts 3200 further includes selecting the base mask from the plurality of base masks according to a mask quality score of the base mask.

In one or more embodiments, the series of acts 3200 includes determining one or more high confidence portions based on mask prediction values of the base mask above a first threshold. The series of acts 3200 also includes determining one or more low confidence portions based on mask prediction values of the base mask between the first threshold and a second threshold. Additionally, the series of acts 3200 includes generating the mask quality score of the base mask by determining a ratio of the one or more high confidence portions to the one or more low confidence portions.

In one or more embodiments, the series of acts 3200 includes determining a mask refinement limit indicating a maximum number of region masks to refine via the mask refinement neural network. The series of acts 3200 further includes determining that the plurality of bounding boxes comprises a higher number of bounding boxes than the mask refinement limit. The series of acts 3200 also includes merging one or more bounding boxes of the plurality of bounding boxes to meet the mask refinement limit.

In one or more embodiments, the series of acts 3200 includes determining a plurality of bounding boxes indicating a plurality of separate connected masked regions corresponding to one or more objects in a base mask of a digital image. The series of acts 3200 also includes determining a merged bounding box by merging a subset of the plurality of bounding boxes based on a proximity of the plurality of bounding boxes and sizes of the plurality of bounding boxes. The series of acts 3200 further includes generating a plurality of region masks based on a portion of the base mask corresponding to a boundary of the merged bounding box and a portion of the base mask corresponding to an additional bounding box of the plurality of bounding boxes. Additionally, the series of acts 3200 includes generating, utilizing a mask refinement neural network, a plurality of refined region masks from the plurality of region masks. The series of acts 3200 also includes combining the plurality of refined region masks into a final mask for the digital image.

In one or more embodiments, the series of acts 3200 includes generating mask quality scores for a plurality of base masks of the digital image according to mask prediction values generated by a mask generation neural network for the plurality of base masks. The series of acts 3200 includes selecting the base mask from the plurality of base masks in response to determining that a mask quality score of the base mask meets a score threshold.

The series of acts 3200 also includes generating a sorted list comprising the plurality of bounding boxes sorted according to sizes of the plurality of bounding boxes. The series of acts 3200 further includes determining, by iteratively searching the sorted list, that a first bounding box is inside a second bounding box based on first coordinates of the first bounding box and second coordinates of the second bounding box. The series of acts 3200 also includes merging the first bounding box and the second bounding box.

In one or more embodiments, the series of acts 3200 includes generating a plurality of refined region masks by generating a first refined region mask for a first region mask corresponding to a first bounding box of the plurality of bounding boxes, and generating a second refined region mask for a second region mask corresponding to a second bounding box of the plurality of bounding boxes. The series of acts 3200 further includes combining the plurality of refined region masks comprises combining the first refined region mask and the second refined region mask to generate the final mask.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 33 illustrates, in block diagram form, an example computing device 3300 (e.g., the client devices or server devices previously described) that may be configured to perform one or more of the processes described above. As shown by FIG. 33, the computing device can comprise a processor(s) 3302, memory 3304, a storage device 3306, an I/O interface 3308, and a communication interface 3310.

In particular embodiments, processor(s) 3302 includes hardware for executing instructions, such as those making up a computer program. As an example, and not by way of limitation, to execute instructions, processor(s) 3302 may retrieve (or fetch) the instructions from an internal register, an internal cache, memory 3304, or a storage device 3306 and decode and execute them. The computing device 3300 includes memory 3304, which is coupled to the processor(s) 3302. The memory 3304 may be used for storing data, metadata, and programs for execution by the processor(s). The memory 3304 may include one or more of volatile and non-volatile memories. The memory 3304 may be internal or distributed memory. The computing device 3300 includes a storage device 3306 includes storage for storing data or instructions. As an example, and not by way of limitation, storage device 3306 can comprise a non-transitory storage medium described above. The computing device 3300 also includes one or more input or output (“I/O”) devices/interfaces 3308, which are provided to allow a user to provide input to (such as user strokes), receive output from, and otherwise transfer data to and from the computing device 3300. These I/O devices/interfaces 3308 may include a mouse, keypad or a keyboard, a touch screen, camera, optical scanner, network interface, modem, other known I/O devices or a combination of such I/O devices/interfaces 3308.

The computing device 3300 can further include a communication interface 3310. The communication interface 3310 can include hardware, software, or both. The communication interface 3310 can provide one or more interfaces for communication (such as, for example, packet-based communication) between the computing device and one or more other computing devices (e.g., computing device 3300) or one or more networks. The computing device 3300 can further include a bus 3312. The bus 3312 can comprise hardware, software, or both that couples components of computing device 3300 to each other.

What is claimed is:

1. A computer-implemented method comprising:
extracting, by at least one processor utilizing an image encoder neural network, encoded feature maps from a digital image;
generating, by the at least one processor utilizing a pixel decoder neural network, a set of mask features from the encoded feature maps generated by the image encoder neural network; and
generating, by the at least one processor utilizing a plurality of query decoder neural networks in connection with a plurality of segmentation tasks for the digital image, a plurality of object segmentation masks from the set of mask features generated by the pixel decoder neural network according to a plurality of separate sets of learned queries.

2. The computer-implemented method of claim 1, wherein:
generating the set of mask features from the encoded feature maps comprises generating the set of mask features as a single set of mask features based on the encoded feature maps utilizing a transformer neural network of the pixel decoder neural network; and
generating the plurality of object segmentation masks comprises generating the plurality of object segmentation masks from the single set of mask features utilizing the plurality of query decoder neural networks.

3. The computer-implemented method of claim 1, wherein generating the plurality of object segmentation masks comprises:
generating, utilizing a first query decoder neural network for a first segmentation task, a first object segmentation mask from the set of mask features generated by the pixel decoder neural network; and
generating, utilizing a second query decoder neural network for a second segmentation task, a second object segmentation mask from the set of mask features generated by the pixel decoder neural network.

4. The computer-implemented method of claim 1, wherein generating the plurality of object segmentation masks comprises:
generating, from the set of mask features, a plurality of sets of modified mask features utilizing a plurality of task adapter neural networks comprising parameters optimized according to corresponding segmentation tasks of the plurality of segmentation tasks; and
generating the plurality of object segmentation masks from the plurality of sets of modified mask features.

5. The computer-implemented method of claim 4, wherein generating the plurality of sets of modified mask features comprises generating a set of modified mask features comprises refining, utilizing a task adapter neural network corresponding to a segmentation task of the plurality of segmentation tasks, the set of mask features using intermediate features generated via a plurality of layers of the pixel decoder neural network.

6. The computer-implemented method of claim 4, wherein generating the plurality of sets of modified mask features comprises upsampling the set of mask features according to dynamically generated sampling points utilizing a data-dependent upsampling layer after the pixel decoder neural network.

7. The computer-implemented method of claim 6, further comprising:
determining a training dataset comprising digital images for a segmentation task of the plurality of segmentation tasks in connection with a task adapter neural network and a query decoder neural network corresponding to the segmentation task; and
jointly optimizing, utilizing the training dataset for the segmentation task, parameters of the data-dependent upsampling layer, the task adapter neural network, and the query decoder neural network to reduce differences between predicted object segmentation masks for the digital images and ground-truth object segmentation masks.

8. The computer-implemented method of claim 1, further comprising:
determining, in response to a request to edit the digital image, a set of segmentation tasks comprising the plurality of segmentation tasks corresponding to one or more image editing operations;
selecting the plurality of query decoder neural networks in response to determining the set of segmentation tasks; and
performing the one or more image editing operations utilizing the plurality of object segmentation masks.

9. The computer-implemented method of claim 8, further comprising:
determining, in response to the request to edit the digital image, an object localization task corresponding to the one or more image editing operations;
selecting an additional query decoder neural network in response to determining the object localization task;
generating, utilizing the additional query decoder neural network, one or more object bounding boxes from the set of mask features generated by the pixel decoder neural network; and
performing the one or more image editing operations utilizing the one or more object bounding boxes.

10. A system comprising:
one or more memory devices comprising a digital image; and
one or more processors coupled to the one or more memory devices that cause the system to perform operations comprising:
determining a plurality of segmentation tasks in connection with a request to perform one or more image editing operations on the digital image;
extracting, utilizing an image encoder neural network, encoded feature maps from the digital image;
generating, utilizing a pixel decoder neural network, a set of mask features from the encoded feature maps generated by the image encoder neural network; and
generating, utilizing a plurality of query decoder neural networks corresponding to the plurality of segmentation tasks, a plurality of object segmentation masks from the set of mask features generated by the pixel decoder neural network according to a plurality of separate sets of learned queries.

11. The system of claim 10, wherein the operations further comprise:
providing, in response to the request, the digital image to a multi-task segmentation model comprising the image encoder neural network, the pixel decoder neural network, and a set of query decoder neural networks; and
selecting, from the set of query decoder neural networks of the multi-task segmentation model, the plurality of query decoder neural networks based on the plurality of segmentation tasks.

12. The system of claim 11, wherein determining the plurality of segmentation tasks comprises:
determining a first segmentation task to segment a foreground and a background in the digital image; and
determining a second segmentation task to perform an instance-aware segmentation on the digital image,
wherein selecting the plurality of query decoder neural networks comprises selecting a first query decoder neural network corresponding to the first segmentation task and a second query decoder neural network corresponding to the second segmentation task.

13. The system of claim 11, wherein generating the plurality of object segmentation masks comprises:
generating, utilizing a first query decoder neural network, a first object segmentation mask from the set of mask features generated by the pixel decoder neural network according to a first set of learned parameters; and
generating, utilizing a second query decoder neural network, a second object segmentation mask from the set of mask features generated by the pixel decoder neural network according to a second set of learned parameters.

14. The system of claim 10, wherein generating the plurality of object segmentation masks comprises:
generating a plurality of modified sets of mask features by refining the set of mask features utilizing a plurality of task adapter neural networks corresponding to the plurality of segmentation tasks; and
generating, utilizing the plurality of query decoder neural networks, the plurality of object segmentation masks from the plurality of modified sets of mask features.

15. The system of claim 14, wherein generating the plurality of modified sets of mask features comprises:
generating upsampled mask features by upsampling the set of mask features according to dynamically generated sampling points utilizing a data-dependent upsampler layer between the pixel decoder neural network and the plurality of query decoder neural networks; and
generating a modified set of mask features by successively refining, utilizing a task adapter neural network comprising a plurality of multi-scale deformable attention layers, the upsampled mask features based on intermediate features generated via a plurality of layers of the pixel decoder neural network.

16. The system of claim 10, wherein the operations further comprise:
determining, for a segmentation task of the plurality of segmentation tasks, a training dataset comprising digital images; and
jointly optimizing, utilizing the training dataset for the segmentation task, parameters of the pixel decoder neural network, a task adapter neural network corresponding to the segmentation task, and a query decoder neural network corresponding to the segmentation task to reduce differences between predicted object segmentation masks for the digital images and ground-truth object segmentation masks.

17. A non-transitory computer readable medium storing instructions thereon that, when executed by at least one processor, cause the at least one processor to perform operations comprising:
extracting, utilizing an image encoder neural network, encoded feature maps from a digital image;
generating, utilizing a plurality of pixel decoder neural networks, a plurality of sets of mask features from the encoded feature maps generated by the image encoder neural network; and
generating, utilizing a plurality of query decoder neural networks in connection with a plurality of segmentation tasks for the digital image, a plurality of object segmentation masks from the plurality of sets of mask features generated by the plurality of pixel decoder neural networks according to a plurality of separate sets of learned queries.

18. The non-transitory computer readable medium of claim 17, wherein:
generating the plurality of sets of mask features from the encoded feature maps comprises:
generating a first set of mask features from the encoded feature maps utilizing a first pixel decoder neural network; and
generating a second set of mask features from the encoded feature maps utilizing a second pixel decoder neural network; and
generating the plurality of object segmentation masks comprises:
generating a first set of one or more object segmentation masks from the first set of mask features utilizing a first query decoder neural network corresponding to a first segmentation task; and
generating a second set of one or more object segmentation masks from the second set of mask features utilizing a second query decoder neural network corresponding to a second segmentation task.

19. The non-transitory computer readable medium of claim 17, wherein:
generating the plurality of sets of mask features comprises generating a plurality of sets of modified encoded feature maps for the plurality of segmentation tasks by refining, utilizing a plurality of task adapter neural networks corresponding to the plurality of segmentation tasks, the encoded feature maps generated by the image encoder neural network; and
generating the plurality of sets of mask features comprises generating, utilizing the plurality of pixel decoder neural networks, the plurality of sets of mask features from the plurality of sets of modified encoded feature maps generated by the plurality of task adapter neural networks.

20. The non-transitory computer readable medium of claim 18, wherein the operations further comprise:
determining a training dataset comprising digital images for a segmentation task of the plurality of segmentation tasks in connection with a task adapter neural network, a pixel decoder neural network, and a query decoder neural network corresponding to the segmentation task; and
jointly optimizing, utilizing the training dataset for the segmentation task, parameters of the task adapter neural network, the pixel decoder neural network, and the query decoder neural network to reduce differences between predicted object segmentation masks for the digital images and ground-truth object segmentation masks.
